(19) United States
(12) Patent Application Publication
(10) Pub. No.: US 2002/0094233 A1
(43) Pub. Date: Jul. 18, 2002

(54) Curling device for forming circular and other flanged shaped connectors and other members for use in joining duct work and other industrial applications, and HVAC flange machine

(75) Inventors: Miller S. Price, Morristown, TN (US); Mark A. Froning, Fletcher, NC (US); Gregory C. Moyers, Arden, NC (US); Herbert J. Fischer, Imperial, MO (US); Paul L. Baker, St. Charles, MO (US)

Correspondence Address: Steven C. Schnedler, Carter & Schnedler, P.A., 56 Central Ave., Suite 101, P.O. Box 2985, Asheville, NC, 28802, US

(73) Assignee: Ovalformer LLC, Arden, NC (US)

(21) Appl. No.: 10/010,933

(22) Filed: Nov. 13, 2001

Related U.S. Application Data
(63) Continuation-in-part of application No. 09/728,845, filed on Dec. 1, 2000.
(60) Provisional application No. 60/168,498, filed on Dec. 2, 1999.
(60) Provisional application No. 60/248,105, filed on Nov. 13, 2000.

(51) Int. Cl. F16B 1/00; F16L 23/00

(52) U.S. Cl. 403/338

(57) ABSTRACT

An apparatus and method for forming circular, oval and irregularly shaped connectors and other curved or arcuate members from stock material. In one embodiment, the apparatus includes a pair of pinch rollers mounted on a support structure and defining a gap therebetween, an adjustment mechanism to selectively vary the gap between the pinch rollers to vary the amount of compression force being exerted on at least a portion of the stock material, and a containment roller positioned proximate the gap between the pinch rollers. The compression force exerted on at least a portion of the stock material causes the stock material to bend thereby forming the curved or arcuate connector or other member. Adjustment of the pinch rollers controls the amount of compression force applied to the stock material which controls the degree of curvature in the finished product. In some embodiments, manual and/or electronic mechanisms including an electronic controller are utilized to adjust the gap between the pinch rollers and to control other operational features of the apparatus. Also disclosed is a machine for making flange assemblies for joining sections of round or flat oval ductwork from a single length of coiled steel stock. The flanges require only a single joint.

### CROSS-REFERENCE TO RELATED APPLICATIONS

This is a continuation-in-part of U.S. patent application Ser. No. 09/728,845, filed Dec. 1, 2000. The benefit of U.S. provisional patent application Ser. No. 60/168,498, filed Dec. 2,1999; and of U.S. provisional patent application Ser. No. 60/248,105, filed Nov. 13, 2000 is claimed.

### BACKGROUND OF THE INVENTION

The invention relates generally to circular, oval and other irregularly shaped members for use in a wide variety of different industrial applications such as for joining together similarly shaped piping, housings, cabinets and heating, ventilation and air conditioning (HVAC) duct work. The invention in a more particular aspect relates to the joining of sections of round (spiral) and flat oval ductwork, such as is employed in heating, ventilation and air conditioning (HVAC) system applications.

In overview, two primary techniques are known for joining round (spiral) and flat oval ductwork.

With reference to FIGS. 23 and 24, the first known technique is to use a collar 220 that is slightly smaller in diameter than the ductwork sections 222 and 224 that are being joined. This collar 220 simply slides inside the ductwork sections 222 and 224, and is then fastened in place via sheet metal screws 226. This type of connection can be acceptable for small ductwork sizes at low pressures (diameters up to 30 inches and pressures less than 2 inches water column).

With reference to FIG. 25, the second known technique, commonly used on larger diameter and high-pressure duct, is to attach to the ends of each ductwork section 232, 234 to be joined respective angle iron flanges 236 and 238 that have been formed to a round shape via a set of powered rolls. The flanges 236 and 238 have L-shaped profiles defined by respective duct-attachment legs 240 and 242 extending generally parallel to the longitudinal axis of the ductwork sections 232 and 234 being joined, and by respective flange-attachment legs 244 and 246 extending radially outwardly generally perpendicularly to the longitudinal axis of the ductwork sections 232 and 234 being joined. The formed angle iron flanges 236 and 238 are fastened to the ductwork sections 232 and 234 via sheet metal screws in pre-drilled holes in the duct-attachment legs 240 and 242, or are welded at spot welds 248 directly to the ductwork sections 232 and 234. Pre-drilled holes 250 are provided in the flange-attachment legs 244 and 246 for bolting the flange sections 236 and 238 together. A sealant is applied to the seam between the ductwork and the angle iron flange, between the spot welds 248 if present. A gasket 252 or bead of sealant is applied to the faces of the flange-attachment legs 244 and 246. The two ductwork sections 232, 234 and angle iron flange 236, 238 assemblies are then fastened together with bolts and nuts.

For flat oval iron flange connections, the round angle iron flange 236, 238 is cut into two halves and two pieces 254, 256 of straight angle iron are welded between the half circles. This “flat oval” shaped flange can then be fastened to the ductwork 232, 234 via sheet metal screws in pre-drilled holes or welded directly to the ductwork 232, 234.

More generally, circular and oval shaped collars, angular brackets, stiffeners, flanged connectors and still other connector or joint type devices for use in a variety of different industrial applications including connecting together similarly shaped HVAC duct sections are well-known in the industry. These circular, oval and other irregularly shaped members typically function as clamps, collars, flanges, brackets, couplings, splicing members, stiffeners or other connecting or joint type assemblies for mating and splicing together non-rectangular piping, housings and other members including HVAC duct work. These non-rectangular flanged connectors and other shaped members are typically made either by hand wherein the arcuate or curved sections associated with such members are manually contoured and bent into the appropriate shape, or such members are fabricated by spinning, forming and trimming a strip of sheet metal material using standard machine tools and standard machining processes. In addition, often times, these irregularly shaped connectors and other members such as an oval flange connector will be made in a piece-meal fashion by welding together two substantially straight sections and two semi-circular formed sections to achieve the resulting oval configuration. These processes are labor intensive and time consuming and include completing at least four separate welds to achieve the finished product.

Typical methods and apparatus for forming circular and oval shaped flange connectors are disclosed in Meinig U.S. Pat. No. 4,516,797 and Hermanson U.S. Pat. No. 5,983,496. In this regard, Meinig U.S. Pat. No. 4,516,797 discloses a method for producing a flanged ring by contouring and then bending an elongated sheet metal strip into an annular shape resulting in a flanged ring connector having an axial slit associated therewith. The machine method used to produce such a flanged ring is known to include roll forming which generally causes tearing or breaking of the sheet metal during the production of the flanged rings when thinner sheet metal material is used. Circular flanged rings or other circular members produced using a roll forming technique also generally do not have an absolutely circular cross section thereby leading to installation problems.

Hermanson U.S. Pat. No. 5,983,496 discloses a method of making circular and oval flanged rings by spinning, forming and trimming a circular band of sheet metal material formed from a strip of stock material welded together with standard machine tools and standard machining processes. This method requires that the steel strips which are rolled into a circular band shape and welded together be positioned within a spinning die which is rotated by means such as a lathe, and that standard machine tools be thereafter employed to stretch, form and trim the circular band strip to produce a circular flanged ring. Oval flanged connectors are similarly produced by cutting a circular flanged ring along a diameter to produce approximately equally sized semi-circular flanged ring portions and thereafter welding linear segments of similar sheet metal material between the semi-circular flanged ring portions to produce the desired oval shaped flanged connector. Although this method is an improvement over the machine method disclosed in Meinig U.S. Pat. No. 4,516,797 it still requires multiple tasks to achieve the end product and the manual formation of the band or circular shaped strip of stock material prior to insertion into the spinning die.

Still other roll forming, pressing and spinning processes are used to shape and form circular and oval connectors and other irregularly shaped members for use in many different types of industrial applications including joining together HVAC duct work, all of which processes include multiple tasking and piece-meal fabrication.

It is therefore desirable to improve the overall fabricating process for forming circular, oval and other irregularly shaped members for use in a wide variety of different industrial applications including joining together correspondingly shaped HVAC duct work; it is desirable to reduce the number of tasks and manual operations necessary to form such circular, oval or other irregularly shaped members; it is desirable to develop a machine which will more efficiently form circular, oval and other irregularly shaped members for use in many different types of industrial applications including use in the HVAC industry; and it is desirable to reduce the overall cost, labor and time associated with forming circular, oval and other irregularly shaped members.

Accordingly, the present invention is directed to overcoming one or more of the problems as set forth above.

### SUMMARY OF THE INVENTION

As used herein, the phrase “circular, oval and other irregularly shaped members” is intended to include circular, oval and other irregularly shaped flanged connectors and other arcuate type members used in the HVAC industry as well as a wide variety of other circular, oval and other irregularly shaped flanged and non-flanged members which can be used in a wide variety of different industrial applications such as flanged and non-flanged members used as stiffeners, brackets, clamps, collars, connectors, couplings, splicing members and other assemblies for holding, connecting, joining or otherwise mating together piping, housings, cabinets, duct work and other members. Although the present disclosure often times refers to connectors used in the HVAC industry, the formation of the circular, oval and other irregularly shaped members disclosed herein is not limited to connectors used in the HVAC industry but includes all industrial applications where such flanged and non-flanged members can be utilized.

In an exemplary embodiment, an apparatus adaptable for receiving stock flanged sheet metal material includes a pair of pinch or compression rollers, or forming rollers, and a containment roller for forming circular, oval or other irregularly shaped members as the flanged material is positioned and fed between such rollers. The pair of pinch rollers are positioned adjacent to each other in spaced apart relationship such that a gap or space exists therebetween. The gap receives and compresses the flanged portion of the stock material as such flanged portion is fed between the pinch rollers. The containment roller is positioned adjacent the pinch rollers and serves as a cam follower or guide for properly positioning and holding the stock flanged material in proper orientation as the flanged portion of such material is fed between the pinch or compression rollers.

The stock flanged sheet metal material used to fabricate the subject members is preferably L-shaped in cross section including a generally wider main body portion and a generally smaller width flanged portion. When the particular irregularly shaped connector or other member is fully formed, the main body portion of such stock flanged material will result in the overlapping mating wall portion of such connector or other member which will be insertably receivable within and attached to one end of a duct section or other mating member, and the flanged portion of the stock flanged material will result in the flanged portion of such connector or other member which will mate with a corresponding flanged portion associated with a similar connector or other member positioned and attached adjacent one end of another duct section or other mating member. Once the flanged portions of adjacent connectors are properly aligned, the adjacent duct sections or other mating sections are joined together using conventional means such as fastening the corresponding flanged portions together using conventional fasteners. Other industrial applications and means for joining adjacent members are recognized and anticipated.

The thickness of the flanged portion of the stock material as well as the size of the space or gap between the pinch or compression rollers will determine the amount of stretching or elongation of the flanged portion of the stock material which will occur during the present forming process thereby determining the radius of the curvature of the connector or other member being formed. As the flanged portion of the stock material is fed between the pinch rollers, the compression forces exerted on such flanged portion squeezes such edge portion thereby reducing the thickness thereof and stretching such flanged portion so as to achieve the outer diameter of the circular, oval or other irregularly shaped member being formed. The compression forces exerted against the flanged portion of the stock material being fed through the pinch rollers cause forces to be exerted so as to bend or curl the stock material around the containment roller thereby forming the desired circular or other arcuate shape associated with the resulting member. If no compression forces are exerted on the stock material as such material passes through the pinch rollers, no curling or bending of such material will occur.

Since the size of the gap or space between the pinch rollers controls the radius of curvature of the stock flanged material being fed through the present apparatus, the disclosed embodiment likewise includes means for adjusting the spacing between the pinch rollers. This can be accomplished either through manual adjustment means, electrical means, or the size of such gap can be computer controlled by utilizing appropriate hardware, software and programming. As a result, the arcuate portions of any irregularly shaped member can be achieved by approximately sizing the space or gap between the pinch rollers to produce the necessary compression forces to yield the desired radius of curvature and the substantially straight or linear portions of any irregularly shaped member can be achieved by sizing the space or gap between the pinch rollers to substantially eliminate the compression force exerted against the stock material as that portion of the stock material passes between the pinch rollers. Once the particularly shaped member is formed using the present device, the opposite end portions of the fabricated member are welded or otherwise fastened together to form the finished product. The present device may also include an adjustable truing roller positioned downstream from and in spaced relationship to the containment roller so as to help true up the radius of curvature or diameter of the particular flanged connector or other member being formed as well as an optional deflector plate appropriately positioned so as to deflect the arcuate member being formed in an upward direction above the plane of the gap between the pair of pinch rollers so as to preclude the formed member from curling around and interfering with the movement of the stock material between the pinch rollers.

The present device enables a user to form circular, oval or other irregularly shaped members in a single machining process thereby substantially reducing the time and labor costs associated with such fabrication. In this regard, the circular, oval or other irregularly shaped member can be easily fabricated by feeding appropriately sized and dimensioned stock material between the pair of pinch rollers or, in the case of circular flanged connectors or other circular members, a plurality of such circular connectors or other circular members can be formed from a single piece of stock material in a continuous spiral pattern wherein each circular connector or other circular member can be severed from the spiral pattern by cutting the same at the appropriate length. In addition, appropriate feed mechanisms can be positioned in front of the present pinch rollers for automatically feeding the stock material between such pinch rollers, or the present apparatus can be incorporated into an assembly process wherein the appropriately shaped stock material is formed and fed directly from a roll former machine into the present apparatus. Other arrangements and configurations are likewise envisioned. Still further, embodiments of the invention substantially simplify the known processes for fabricating circular, oval and other irregularly shaped flange connectors or other members for use in connecting similarly shaped HVAC duct sections as well as other industrial applications; it eliminates the spinning and trimming processes associated with the method disclosed in Hermanson U.S. Pat. No. 5,983,496; and it provides more accurately sized circular, oval and other irregularly shaped members which further facilitates the insertion and connection of such members into duct work and other industrial applications.

A machine embodying the invention for making generally L-shaped flanges for joining sections of flat oval ductwork includes an input section for receiving a strip of sheet metal stock material, and a cutter for cutting the sheet metal stock material into lengths corresponding to individual flanges being made. The machine additionally includes a set of angle-forming rolls for forming each length of sheet metal stock material into an angled length material having a generally L-shaped profile, as well as a set of shaping rolls for forming the angle lengths of material into flat oval flanges, generally L-shaped in profile and requiring only a single joint.

These and other aspects and advantages of the present invention will become apparent to those skilled in the art after considering the following detailed description in connection with the accompanying drawings.

### BRIEF DESCRIPTION OF THE DRAWINGS

FIG. 1 is a front elevational view of one embodiment of the present curling device constructed in accordance with the teachings of the present invention;

FIG. 2 is a top platform view of the present curling device illustrated in FIG. 1;

FIG. 3 is a partial side elevational view of one embodiment of the present curling device;

FIG. 4 is a partial side elevational view of another embodiment of the present curling machine;

FIG. 5 is a perspective view of a circular flanged connector formed using the present curling device;

FIG. 6 is a top platform view of a strip of stock flanged material utilized to form the connector illustrated in FIG. 5;

FIG. 7 is a cross-sectional view of the strip of stock flanged material illustrated in FIG. 6 taken along the line 7-7;

FIG. 8 is a perspective view of an oval flanged connector formed using the present curling device;

FIG. 9 is a top platform view of a strip of stock flanged material utilized for forming the oval connector illustrated in FIG. 8;

FIG. 10 is a cross-sectional view taken along line 10-10 of FIG. 9;

FIG. 11 is a cross-sectional view taken along line 11-11 of FIG. 8;

FIG. 12 is a cross-sectional view taken along line 12-12 of FIG. 9;

FIG. 13 is a cross-sectional view of another embodiment of a strip of stock flanged material which could be utilized in conjunction with the present curling device;

FIGS. 14-17 illustrate another method for making an oval flanged connector and further illustrate use of the present curling device in combination with a roll forming machine;

FIGS. 18-21 illustrate still other irregularly shaped member profiles which can be formed utilizing the present curling device; and

FIG. 22 is an exemplary schematic illustration of one embodiment of a control system for adjusting various parameters associated with the present curling device to achieve the formation of a particularly shaped flanged connector or other irregularly shaped member.

FIG. 23, referenced hereinabove, is a three-dimensional view showing a pair of flat oval ductwork sections being joined employing a prior art collar;

FIG. 24, referenced hereinabove, is a sectioned three-dimensional view taken on line 24-24 of FIG. 23;

FIG. 25, referenced hereinabove, is a sectioned three-dimensional view, generally in the same orientation as FIG. 24, showing prior art angle iron flanges joining two ductwork sections;

FIG. 26 schematically depicts a machine embodying the invention for making generally L-shaped flanges for joining sections of either flat oval or round ductwork;

FIG. 27 is a cross-sectional view of ductwork sections being joined employing flanges embodying the invention;

FIG. 28 is a partially broken away end view depicting the positioning of the clips of FIG. 27;

FIG. 29 is a cross-sectional view depicting flat sheet metal stock material entering the machine of FIG. 26;

FIG. 30 is a cross-sectional view depicting the profile of angled lengths of material following the angle-forming rolls of the machine of FIG. 26;

FIG. 31 is a view similar to FIG. 30, depicting the application of sealant;

FIG. 32 is a longitudinal view of an L-shaped flange embodying the invention for joining sections of round ductwork;

FIG. 33 is a longitudinal view of a flange embodying the invention for joining sections of flat oval ductwork;

FIG. 34 is a cross-sectional view depicting an alternative configuration of clip and angle for joining ductwork sections;

FIG. 35 is a view of the angle of FIG. 34 in isolation;

FIG. 36 is a cross-sectional view of the clip of FIG. 34, in isolation;

FIG. 37 is a side elevational view of a set of shaping rolls included in a particular embodiment of the invention;

FIG. 38 is a top plan view taken on line 38-38 of FIG. 37; and

FIGS. 39, 40 and 41 are top plan views depicting the shaping rolls of FIGS. 37 and 38 at several stages during operation.

### DETAILED DESCRIPTION

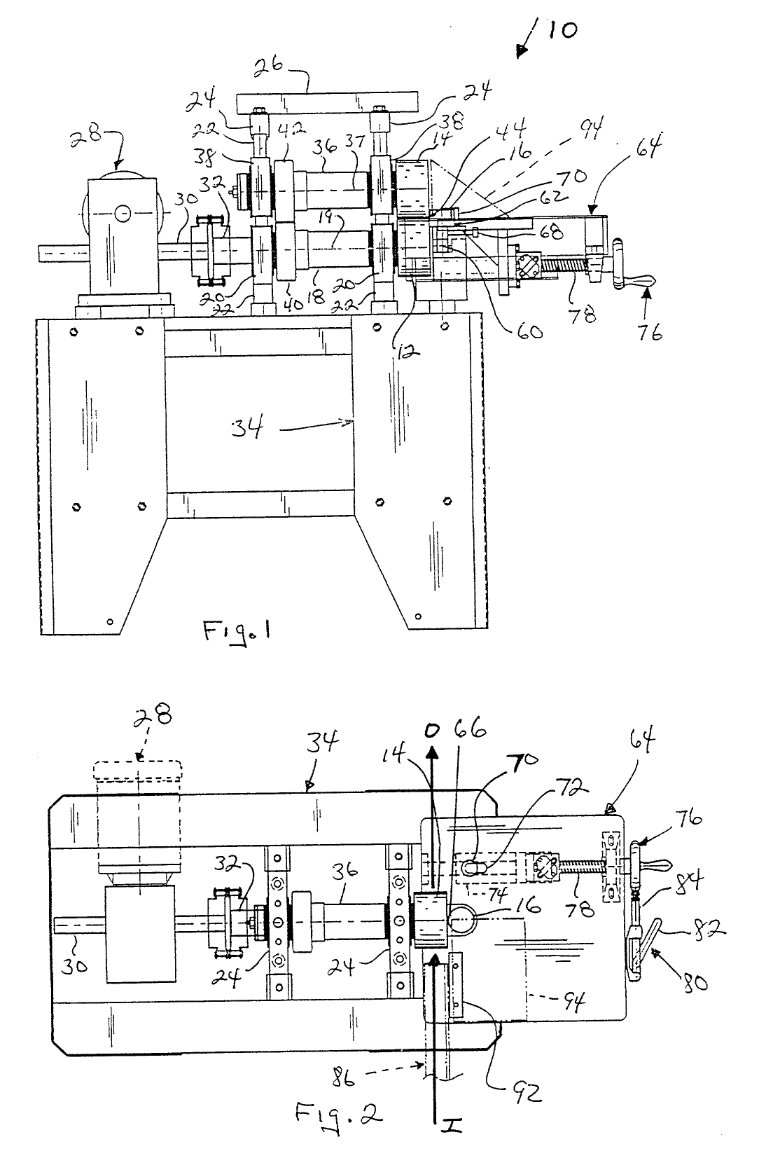

Referring to FIGS. 1 and 2, there is shown one embodiment of an apparatus or curling device 10 constructed according to the teachings of the present invention. The curling device 10 is specifically designed to form circular, oval or other irregularly shaped members for use in a wide variety of industrial applications including, but not limited to, connecting together similarly shaped piping, housings, cabinets and adjacent HVAC duct sections such as the substantially circular flanged connector 86′ illustrated in FIG. 5, the substantially oval flanged connector 98′ illustrated in FIG. 8, and the irregularly shaped flanged connectors 124,126 and 128 illustrated in FIGS. 18-20. The curling device 10 includes a pair of pinch or compression rollers, or forming rollers 12 and 14, a containment roller 16, and appropriate support structure for operatively holding the rollers 12,14 and 16 in operative position as will be hereinafter explained. The lower pinch roller 12 is rotatably coupled to one end portion of a lower rotatable spindle assembly or shaft 18 having an axis of rotation 19 as best shown in FIG. 1, the lower spindle assembly 18 being operatively supported for rotational movement by a pair of lower bearing block members 20. Appropriate journals and bearings are housed within the block members 20 for coupling the lower spindle assembly 18 to the bearing block members 20 for rotation thereabout. The lower bearing block members 20 are likewise connected to an appropriate support frame structure such as the members 22, 24 and 26 illustrated in FIG. 1. A conventional motor or other appropriate drive assembly or power means 28 having an output shaft 30 associated therewith is likewise coupled to the opposite end portion 32 of the lower spindle assembly 18 via a conventional coupling arrangement as illustrated in FIG. 1 for rotationally driving the lower pinch roller 12. In the particular embodiment illustrated in FIGS. 1 and 2, the present device 10 is operatively positioned on top of a work stand or other base-like structure 34.

In similar fashion, the upper pinch or compressor roller 14 is rotatably coupled to one end portion of an upper rotatable spindle assembly or shaft 36 having an axis of rotation 37, the upper spindle assembly 36 being similarly operatively supported for rotational movement via a similar pair of upper bearing block members 38 as best illustrated in FIG. 1. The upper bearing block members 38 likewise include appropriate journals and bearings for rotatably coupling the upper spindle assembly 36 to the bearing block members 38 for rotation thereabout and the bearing block members 38 are likewise connected to an appropriate support frame structure such as the same support structure associated with lower bearing block members 20. The upper pinch roller 14 is rotatable with the upper spindle assembly 36 which is driven by the rotation of the lower spindle assembly 18 via a conventional gearing arrangement such as the gear members 40 and 42.

The lower and upper pinch rollers 12 and 14 are positioned relative to each other such that a space or gap 44 exists therebetween. Since the size of gap or space 44 will control the amount of compressive force being applied to the flanged portion of the stock material being fed between the rollers 12 and 14 as will be hereinafter further explained, the lower and upper pinch rollers 12 and 14 are adjustably moveable relative to each other in order to adjust and control the space or gap 44. Although it is recognized and anticipated that either one or both of the rollers 12 and 14 may include adjustment mechanisms to selectively vary the space or gap 44 between such rollers, for exemplary purposes only, one mechanical embodiment and one electrical embodiment of an adjustment mechanism for adjustably moving the upper pinch roller 14 relative to the lower pinch roller 12 are disclosed and described herein.

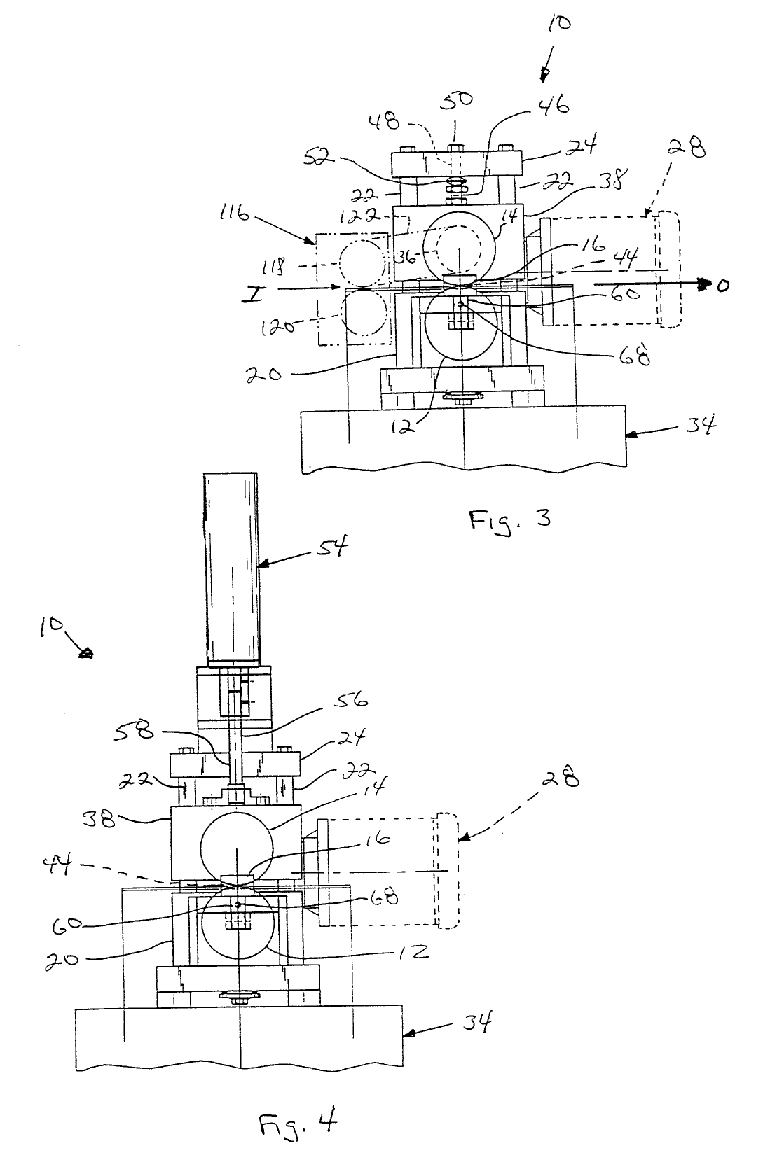

In the embodiment illustrated in FIG. 3, the manual adjustment mechanism illustrated therein will be described with respect to only one upper bearing block member 38. As will be hereinafter explained, a similar adjustment mechanism may be associated with the other upper bearing block member 38. The adjustment mechanism for adjusting the space or gap 44 between pinch rollers 12 and 14 includes a pair of support post members 22 which extend respectively through the upper bearing block member 38 adjacent each opposite end portion thereof, these support post members 22 functioning as a pair of guide bars for allowing the upper bearing block member 38 to travel therealong. The support post members 22 are appropriately attached at one end portion thereof to the support member 24 as best illustrated in FIGS. 1 and 3. A threaded member 46 is threadedly secured at one end portion thereof to the bearing block member 38 which, in turn, is appropriately coupled to the upper spindle assembly 36 as previously explained and illustrated in FIG. 1. The opposite end portion of the threaded member 46 passes through a correspondingly threaded opening 48 in support member 24 and is connected to a fastening member 50 such that rotation of the fastening member 50 will correspondingly move the respective bearing block member 38 in a vertical direction so as to selectively adjust the position of the upper spindle assembly 36 relative to the lower spindle assembly 18. Since the upper spindle assembly 36 is coupled to the upper pinch roller 14 and the lower spindle assembly is coupled to the lower pinch roller 12, adjustment of the upper bearing block member 38 will likewise selectively adjust the position of the upper pinch roller 14 relative to the position of the lower roller 12. This adjustment affects adjustment of the space or gap 44 between pinch rollers 12 and 14.

An appropriate optional spring member 52 such as the disc spring illustrated in FIG. 3 may be utilized to apply an appropriate biasing force to the upper pinch roller 14 as the stock flanged material is being fed between the rollers 12 and 14. This biasing force ensures appropriate tension is applied to the stock material as it is being fed between the pinch rollers 12 and 14. Although the operation of the threaded member 50 has been described with only one of the pair of upper bearing block members 38, it is recognized that a similar arrangement will be associated with the other bearing block member 38. However, it is also recognized that since the actual changes and adjustments made to the size of the space or gap 44 will be relatively small, and since the upper spindle assembly 36 is capable of rotatably operating within the bearing block members 38 within some degree of angular offset with respect to its axis of rotation 37, the size adjustment of the gap or space 44 can be accomplished by utilizing a single adjustment mechanism associated with the upper bearing block member 38 positioned adjacent the upper pinch roller 14.

FIG. 4 illustrates another embodiment of an adjustment mechanism for adjustably moving the upper pinch roller 14 relative to the lower pinch roller 12 wherein an electrical actuator or servo motor is utilized to vertically adjust the position of the upper bearing block member 38. The servo motor 54 is operatively positioned above support member 24 by any suitable means and includes an electrically actuated armature shaft 56 which extends through an opening 58 associated with member 24 and has its terminal end portion secured or otherwise engaged with the upper bearing block member 38. Electrical actuation of the servo motor 54 will cause the armature shaft 56 to move in a vertical direction thereby correspondingly moving the bearing block member 38 which is coupled to the upper spindle assembly 36 in a vertical direction so as to again selectively adjust the position of the upper pinch roller 14 relative to the position of the lower pinch roller 12. Actuation of the servo motor 54 can be accomplished via any conventional means such as through the use of an electrical switch or foot pedal, or such servo motor 58 could be coupled to an electronic controller for computer controlled operation as will be hereinafter further explained. Here again, a similar servo motor arrangement can be associated with the other bearing block member 38, if necessary.

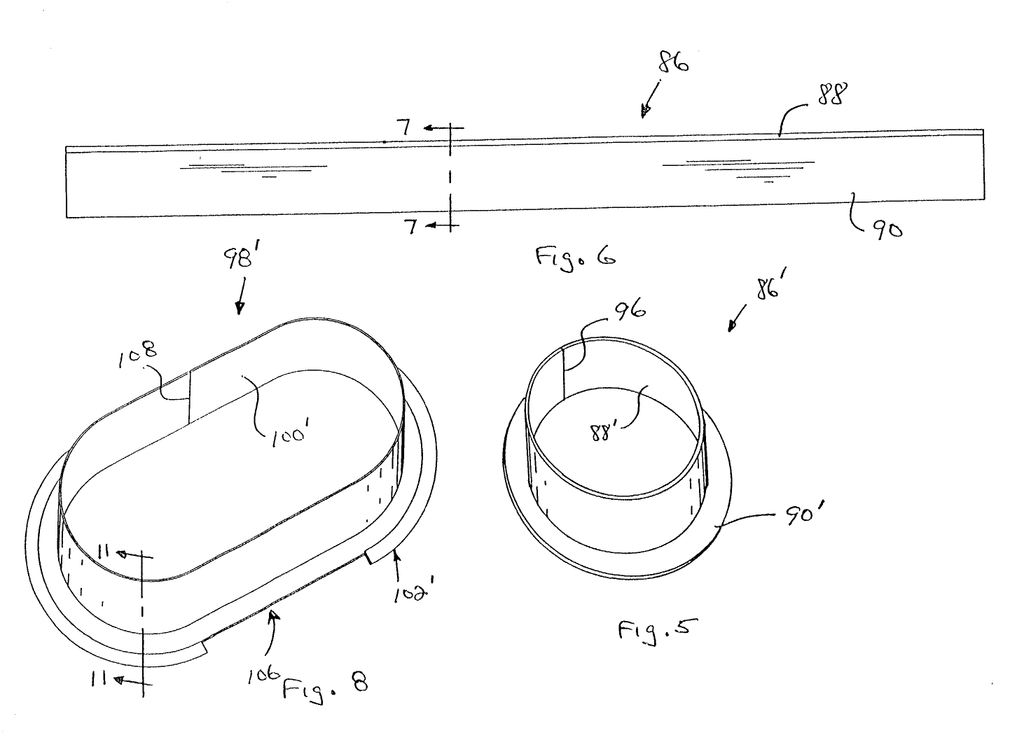

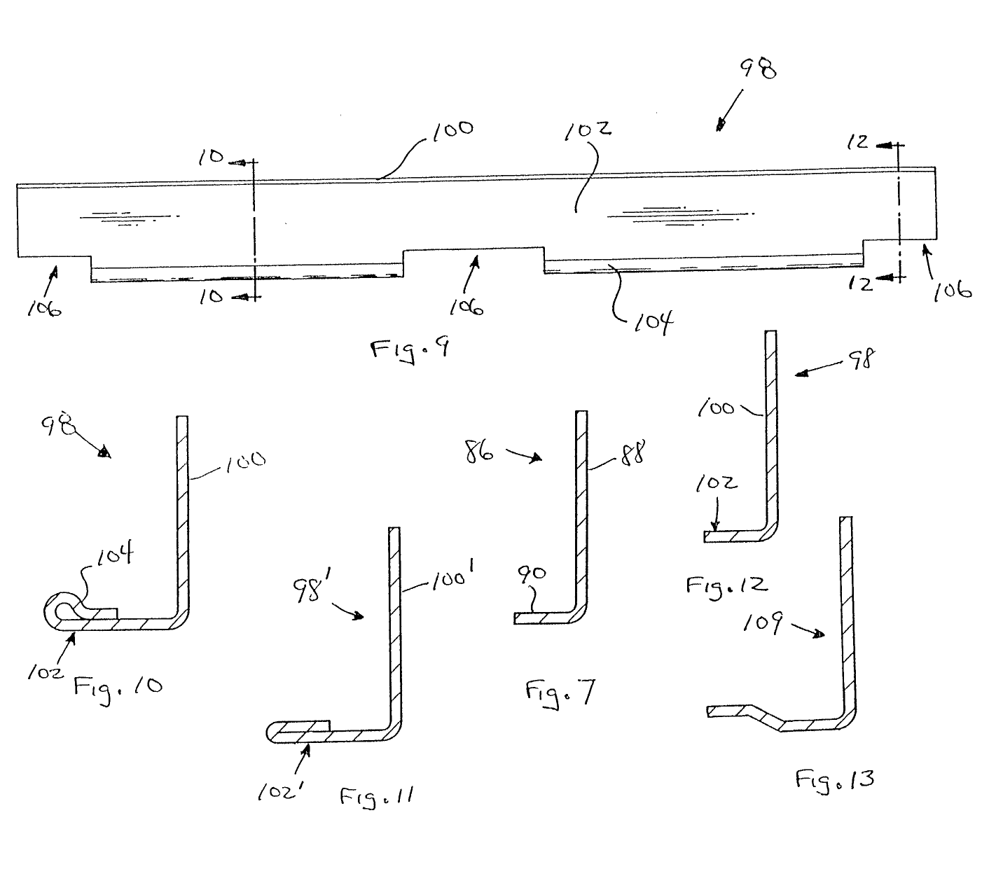

The present curling device 10 likewise includes a containment or holding roller 16 positioned adjacent the pinch rollers 12 and 14 in spaced apart relationship thereto as best shown in FIG. 2. The containment roller 16 includes a shaft portion 60 which is positionable through an opening 62 associated with a work platform or shelf member 64 which extends adjacent the space or gap 44 between the pinch rollers 12 and 14, the shaft portion 60 being held fixedly in place through the use of a locking screw 68 as best shown in FIG. 1 which butts against shaft portion 60 and holds the containment roller 16 in proper position. When the containment roller 16 is properly positioned, a space 66 is defined between the containment roller 16 and the pinch rollers 12 and 14. The space 66 is adaptable to allow the main body wall portion of the stock flanged material such as the wall portion 88 (FIG. 7) of stock material 86 (FIG. 6) to pass therethrough as the flanged portion 90 (FIG. 7) of such stock material 86 (FIG. 6) is fed between the pinch rollers 12 and 14. The containment roller 16 serves as a cam follower or guide member for guiding the stock material between the pinch rollers 12 and 14 and, importantly, it also serves to receive at least a portion of the transverse component of the compressive force being exerted against the stock material as such material is passed between the pinch rollers 12 and 14. It is this component of the compressive force exerted against the stock material and against the containment roller 16 which initiates the bending or curling action resulting in forming the particularly arcuate shaped flanged connector or other non-flanged member as will be hereinafter further explained. The containment roller 16 allows the main body wall portion of the stock material to push thereagainst during the curling operation.

The present curling device 10 likewise includes a truing roller 70 positioned downstream from the containment roller 16 as the stock flanged material is fed through the pinch rollers 12 and 14 as best shown in FIG. 2. The truing roller 70 is positionable within a slot 72 located in the work platform 64 and is engagable with an appropriate mechanism positioned underneath the platform 64 for adjustably moving the position of the truing roller 70 along the length of the slot 72 so as to engage the stock flanged material as it passes through the pinch rollers 12 and 14 and around the containment roller 16. In the embodiment illustrated in FIGS. 1 and 2, the truing roller 70 is threadedly engagable with a member 74 which, in turn, is moveable in a direction parallel to slot 72 through the use of hand crank assembly 76. As the crank assembly 76 is rotated, screw mechanism 78 will selectively adjust the position of the truing roller 70 within the slot 72. The truing roller 70 can therefore be appropriately positioned relative to the containment roller 16 so as to help true up the radius of curvature or diameter of the particular circular, oval, arcuate or other irregularly shaped member being formed as the stock material is being curved or bent into its desired shape. In this regard, based upon the desired radius of curvature or diameter to be imparted to the formed connector or other member via the present curling process, the truing roller 70 can be appropriately positioned relative to the containment roller 16 to engage the stock material during its bending process so as to help true up and establish the desired radius of curvature or diameter. Although FIGS. 1 and 2 illustrate a mechanical means for adjusting the position of the truing roller 70, this adjustment or movement of the truing roller 70 within the longitudinal slot 72 can likewise be accomplished through other known means such as through the use of a servo motor arrangement similar to the operation of servo motor 54 for selectively adjusting the gap 44 between pinch rollers 12 and 14 as illustrated in FIG. 4, or through the use of other known electrical or power means. In addition, it is also recognized and anticipated that any power means used to adjust the position of the truing roller 70 can likewise be coupled to an electronic controller for operatively controlling such adjustment as will be herinafter further explained. Once the truing roller 70 is properly positioned, an appropriate clamping or brake mechanism such as the mechanism 80 illustrated in FIG. 2 can be utilized to hold and lock the truing roller 70 in its selected position. In the mechanism 80 illustrated in FIG. 2, movement of the clamping handle 82 moves the locking pin member 84 into and out of engagement with the crank handle assembly 76.

Use and operation of the present curling machine 10 can best be described with reference to FIGS. 5-7 with respect to forming a circular flanged connector; with reference to FIGS. 8-12 and 14-17 with respect to forming an oval flanged connector; and with reference to FIGS. 18-20 with respect to forming irregularly shaped flanged connectors. Although use and operation of the present device 10 will be described with respect to the above-identified flanged connectors commonly used in the HVAC industry, the formation of the circular, oval, arcuate and other irregularly shaped members disclosed herein is not limited to use in the HVAC industry but is intended to include all industrial applications where both flanged and non-flanged members of this type can be used. With that thought in mind, referring first to FIG. 57, a circular flanged connector such as the finished connector 86′ illustrated in FIG. 5 having a main body or wall portion 88′ and a flange portion 90′ can be formed using the present curling device 10 by feeding a substantially straight L-shaped or flanged shaped strip of stock material 86 as illustrated in FIGS. 6 and 7 between pinch rollers 12 and 14 as will be hereinafter explained. The stock material 86 includes a main body portion 88 and a flanged portion 90 as illustrated in FIGS. 6 and 7, the main body portion 88 being sized and dimensioned so as to both substantially correspond to the inside diameter of the finished circular connector 86′ and to substantially correspond to the circular wall or sleeve portion 88′ associated with the finished connector 86′ after the curling or forming operation. The circular wall portion 88′ is dimensioned to be insertably received within one end of a circular duct section or other member for attachment thereto while the flanged portion 90′ will be used to mate with a corresponding flanged portion 90′ associated with another circular connector 88′ for attachment thereto thereby joining adjacent duct sections or other adjacent members. As the strip of stock material 86 is curled or bent into a circular configuration as illustrated in FIG. 5, the flanged portion 90 must be stretched or elongated so as to form the flange portion 90′ associated with the finished circular connector 86′ illustrated in FIG. 5. In other words, the outer portion of the flange 90 associated with the strip of stock material 86 must be stretched in order to achieve the outer diameter of the flange portion 90′ associated with connector 86′. This stretching, and the resulting curling of the strip of stock member 86, is achieved by feeding the flanged portion 90 of strip member 86 between the pinch rollers 12 and 14.

n this regard, the strip of stock material 86 is fed into the curling device 10 such that the flanged portion 90 is compressed between the pinch rollers 12 and 14 and the main body or wall portion 88 is positioned in the space 66 between the pinch rollers 12 and 14 and the containment roller 16. An infeed guide member such as the member 92 (FIG. 2) may be utilized to help guide and align the strip of stock material 86 for proper feeding through the pinch rollers 12 and 14 and the space 66. Although it is generally preferred that the main body portion 88 be positioned so as to extend upwardly from the space or gap 44 between the pinch rollers 12 and 14, depending upon the specific construction of the device 10 and the positioning of the work platform 64, the strip of stock material 86 may be oriented such that the main body or wall portion 88 will extend downwardly within the space 66 between the rollers 12, 14 and 16.

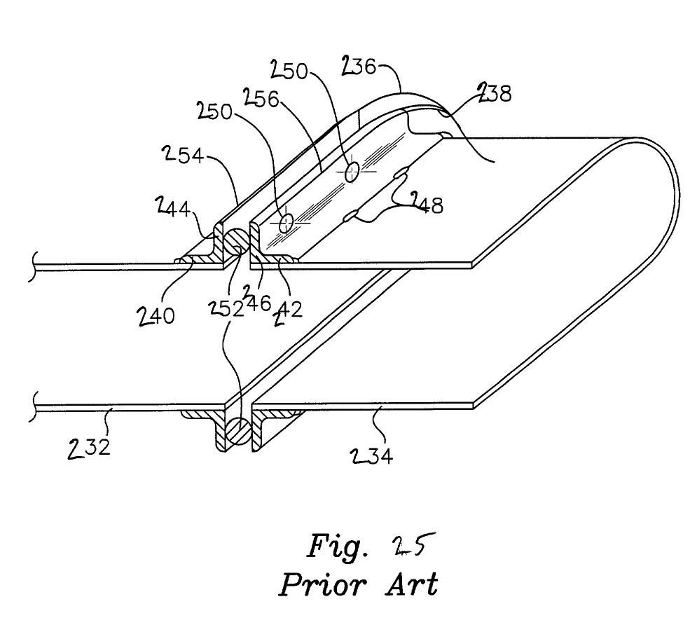

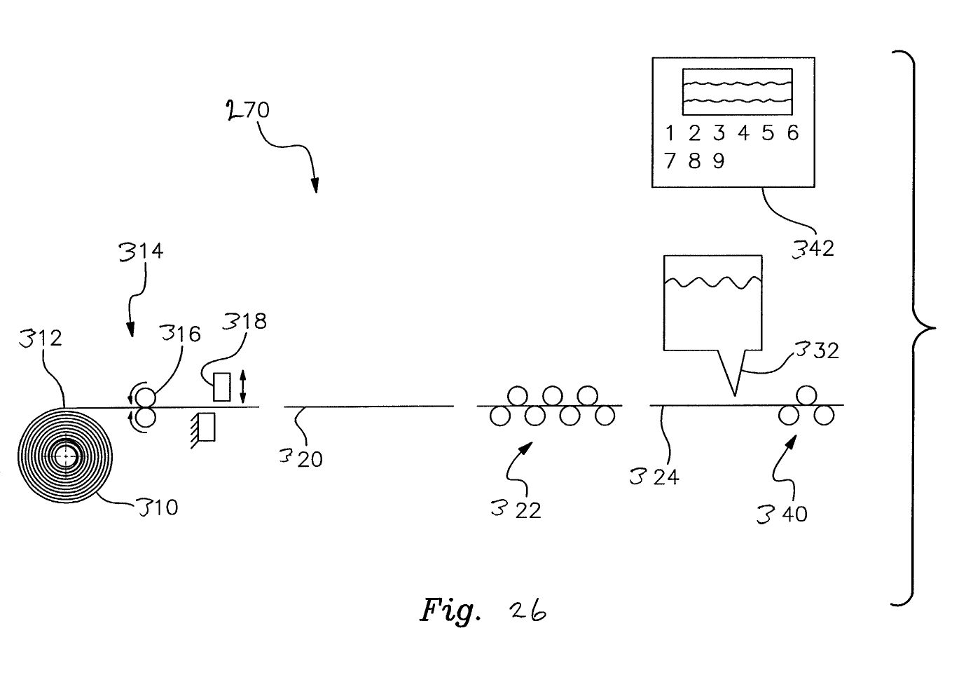

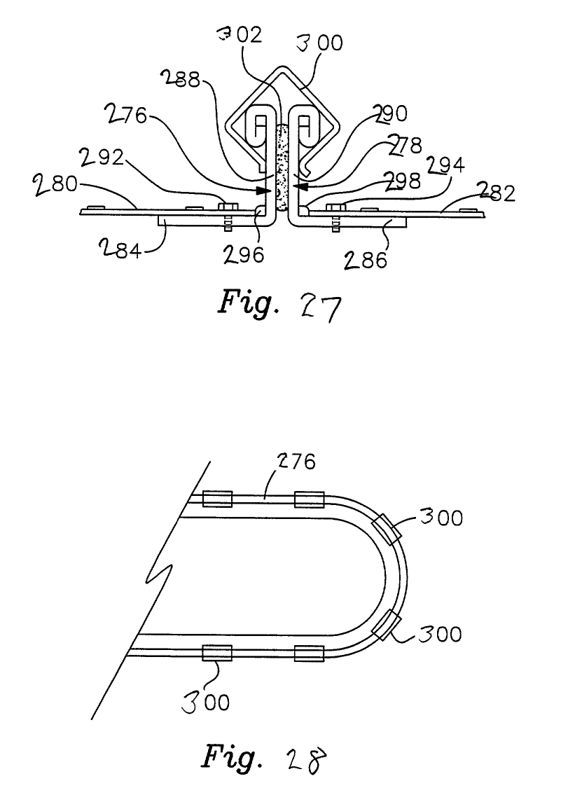

The stock material 86 is fed into the gap 44 between rollers 12 and 14 along an inlet axis, identified by the arrow 1, as best illustrated in FIGS. 2 and 3. The stock material is aligned along the inlet axis I by the work platform 64 and the infeed guide member 92. The outlet axis, identified by the arrow O, as best illustrated in FIGS. 2 and 3 extends directly opposite the inlet axis I downstream from the gap 44. Both the inlet axis I and the outlet axis O are aligned as illustrated in FIGS. 2 and 3. In addition, the inlet axis I and the outlet axis O are co-planar with the platform 64. When the curling device 10 compresses the stock material 86, such compression causes the stock material 86 to bend or curve away from the outlet axis O as best illustrated in FIG. 15. This is different from a typical cold forming machine which produces beams and other members as straight as possible along the outlet axis O.

Depending upon the thickness of the flanged portion 90 associated with the strip of stock material 86, the space or gap 44 between pinch rollers 12 and 14 can be set so as to achieve the required compression force to both stretch and curl the substantially straight strip of stock material 86 as the flanged portion 90 of such material is fed between the pinch rollers 12 and 14. This cold forming and compressing of the flanged portion 90 causes stretching and elongation of such flanged portion along its linear length thereby achieving the necessary circumference and outer diameter of the flanged portion 90′ associated with the formed connector 86′ while, at the same time, causing a sufficient transverse force to engage the main body portion 88 of strip material 86 with the containment roller 16 and the optional truing roller 70 to cause a curling or bending motion to occur. This curling or bending motion results in bending and forming the substantially straight strip of stock material 86 into the formed circular flanged connector 86′ as illustrated in FIG. 5. Shrinking the thickness of the flanged portion 90 causes stretching of such flanged portion and results in the extra length necessary in order to achieve the outer diameter associated with the formed flange portion 90′. The inherent strength of the material undergoing the present compression forces causes the curling or bending of the substantially straight strip of stock material 86. As a result, the size of the space or gap 44 between the pinch rollers 12 and 14 controls the radius of curvature or diameter of the formed connector 86′ and such space or gap 44 can be predetermined and calibrated based upon the thickness or gauge of the flanged portion 90 being utilized.

In the case of a circular flanged connector such as the connector 86′ or any other irregularly shaped member formed in accordance with the teachings of the present invention, the strip of material 86 can be appropriately sized in length to achieve the circumference and diameter of the desired end product 86′. It is also recognized and anticipated that a plurality of circular flanged connectors 86′ or other circular members can be formed by feeding a substantially straight continuous strip of stock material between the pinch rollers 12 and 14 so as to form a continuous spiral of circular members wherein each formed member 86′ can be severed from the continuously formed spiral of members by cutting the same at the appropriate length to form the finished connector or member 86′. In this particular application, an optional deflector member such as the plate member 94 illustrated in FIGS. 1 and 2 may be appropriately positioned and attached to the work platform 64 to deflect the arcuate connectors 86′ or other arcuate members being formed in an upward direction above the plane of the platform 64 and the gap 44 so as to preclude the formed connectors or other members from curling around and interfering with the movement of the strip of stock material between the pinch rollers 12 and 14. Whether the circular flanged connector 86′ or other circular member is formed from an appropriately sized strip of stock material 86, or whether such circular connector 86′ or other circular member is formed by severing the same from a continuously formed spiral of such members, the only task remaining to complete the formation of the connector 86′ is to weld or otherwise join the opposed end portions of the finished connector such as joining such end portions at the joint or seam 96 illustrated in FIG. 5.

FIG. 8 illustrates a formed oval flanged connector 98′ constructed in accordance with the teachings of one embodiment of the present invention utilizing the present curling device 10. The formed oval connector 98′ includes an annular wall member or main body portion 100′ for insertion within one end portion of a compatibly shaped duct section or other member and a flanged portion 102′ for joining adjacent duct sections or other adjacent members. As in the case of circular flanged connector 86′ (FIG. 5), the oval flanged connector 98′ or other oval member is formed by feeding a substantially straight strip of stock material 98 having a main body or wall portion 100 and a flanged portion 102 as best illustrated in FIGS. 9 and 10 between rollers 12, 14 and 16. As best illustrated in FIG. 10, the flanged portion 102 associated with strip material 98 includes a folded over hem portion 104 which increases the thickness of the outer portion of the flange 102 for compression and stretching when fed between the pinch rollers 12 and 14. As best seen in FIG. 9, the strip of stock material 98 includes a plurality of cut outs 106 associated with the flanged portion 102. These cut out portions 106 are positioned and located so as to coincide with the substantially straight parallel wall portions 100′ associated with the formed oval connector 98′ and are dimensioned widthwise relative to the flanged portion 102 so as to substantially eliminate the rolled over hem portion 104 associated therewith as best shown in a cross-sectional view taken through a cut-out portion 106 as illustrated in FIG. 12. Since the gap 44 is set based upon the increased thickness of the flange 102 provided by the hem portion 104, the bending or curling of the stock material 98 occurs due to the compression forces applied to the hem portion 104 when the flanged portion 102 is fed between the pinch rollers 12 and 14. Since the cut out portions 106 substantially eliminate the hem portions 104 and the increased flange thickness provided thereby, when the cut out portions 106 pass between the rollers 12 and 14, no compression forces are exerted thereagainst. As a result, when the cut out portions 106 pass between the pinch rollers 12 and 14, no bending occurs and that portion of the flanged material 102 is allowed to pass through the curling device 10 unaffected. As a result, the cut out portions 106 can be strategically positioned and located along a linear strip of stock material as illustrated in FIG. 9 so as to achieve the overall oval shaped connector 98′ or other oval shaped member as illustrated in FIG. 8.

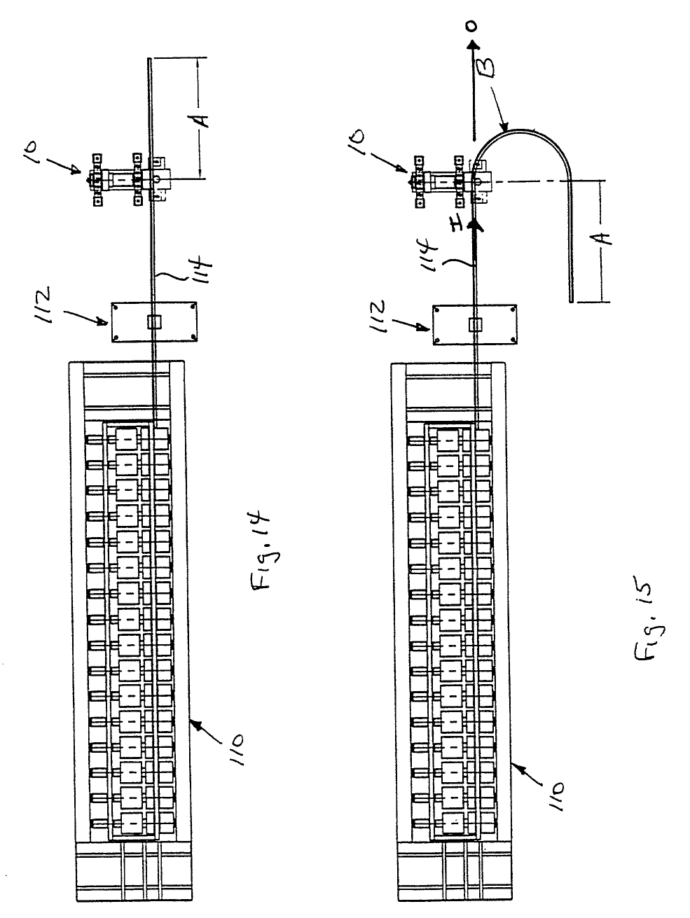

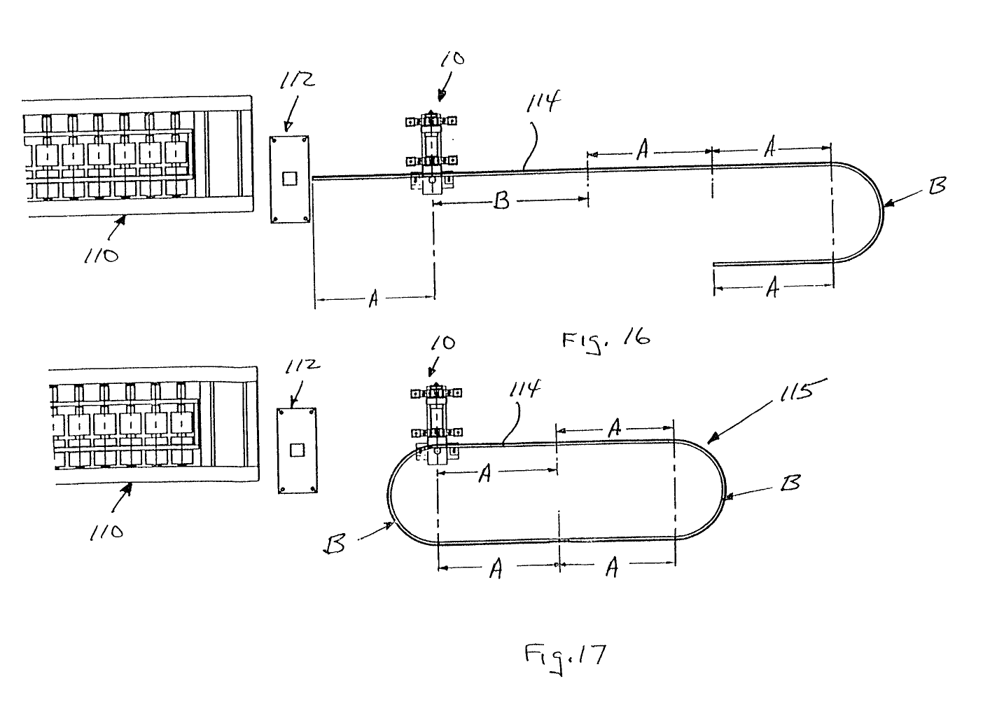

Here again, as with the stock material 86, the strip of stock material 98 can likewise be appropriately dimensioned so as to achieve the desired oval circumference and the respective opposite end portions of the formed oval connector 98′ can thereafter be welded or otherwise joined together along joint or seam 108 to complete the finished product. Although the rolled over hem portion 104 associated with the strip of stock material 98 provides the necessary thickness as compared to the cut out portions 70 for applying sufficient compression force to affect the bending of the semi-circular end portions of the oval connector 98′, it is recognized and anticipated that other flanged edge portions could likewise be utilized to achieve this purpose including the flange configuration 109 illustrated in FIG. 13 as well as use of a substantially uniform flanged edge portion such as the flange configuration illustrated in FIG. 11. In this situation, the cut out portions 106 may extend a greater distance inwardly towards the annular wall portion 100 so as to relieve the compression forces when that portion of the flanged edge passes between the pinch rollers 12 and 14. It is also recognized and anticipated that the flanged portion 102 may include a hem portion folded over in the opposite direction as compared to hem portion 104. Utilizing a strip of stock material similar to strip material 98 enables a user to form an oval flanged connector or other oval member similar to oval connector 98′ in a single machining operation by feeding a properly configured and dimensioned strip of stock material between pinch rollers 12 and 14.

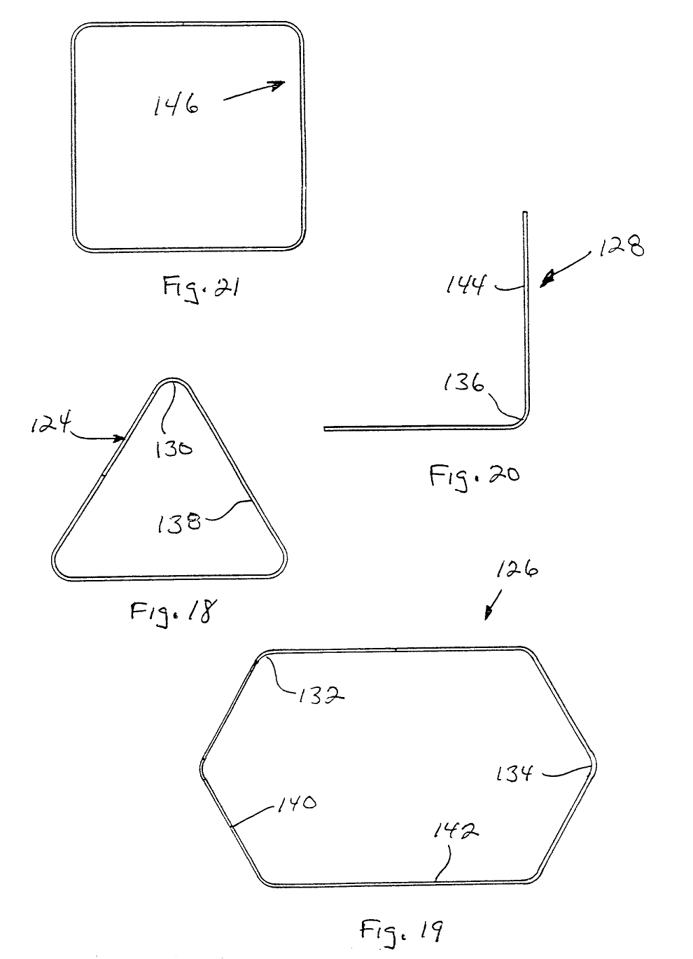

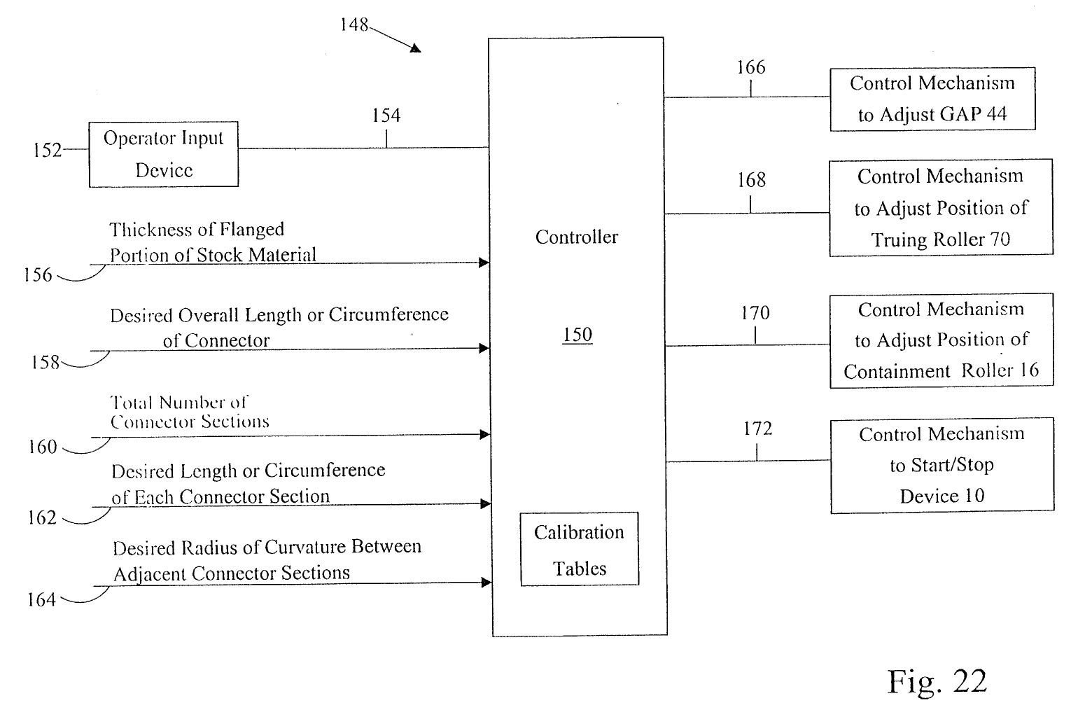

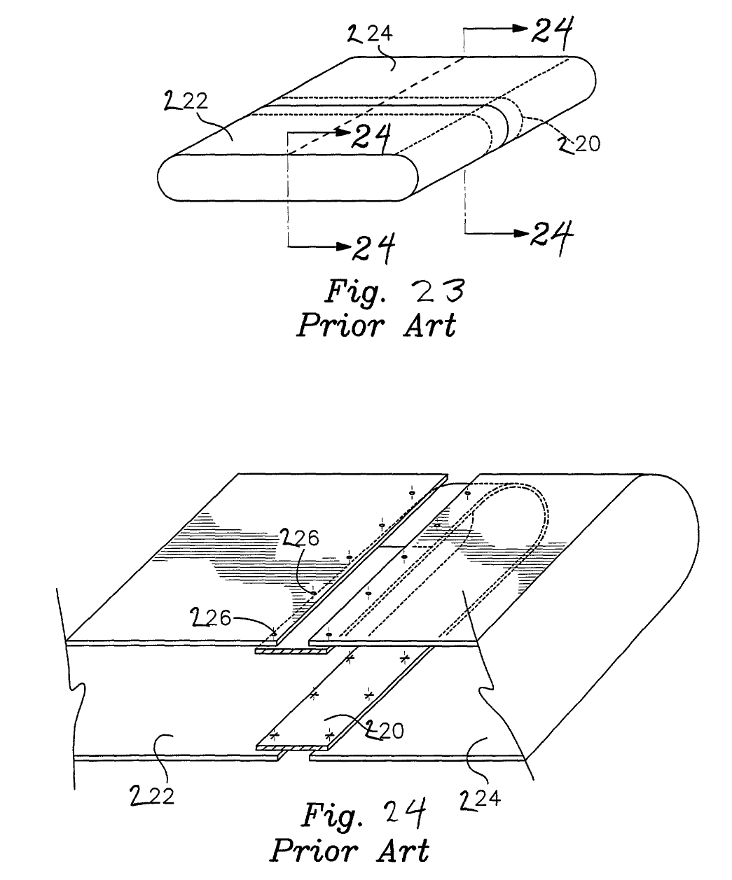

It is also recognized and anticipated that the substantially straight or linear sections of the oval connector 98′ can likewise be formed by merely adjusting the gap 44 between the pinch rollers 12 and 14 such that no compression force is applied to the flanged portion of the stock material being fed between such rollers. This can be accomplished by either stopping the curling device 10 at the appropriate location along the length of the stock material such as after one of the semi-circular sections of the oval connector 98′ illustrated in FIG. 8 has been formed and thereafter adjusting the space or gap 44 between the rollers 12 and 14 sufficiently to allow the next portion of the flanged stock material to pass therebetween without exerting any compression force thereagainst. Since no compression forces will be exerted against the flanged portion of the stock material for a particular length of such material, no bending or curling will take place and a substantially straight section of the formed oval connector 98′ will result. Once one of the substantially straight or linear sections of the oval connector 98′ has passed through the curling device 10, the device can again be stopped and the gap 44 can again be adjusted so as to apply sufficient compression forces to the next portion of the flanged stock material passing between the rollers 12 and 14 to again generate the curling or bending action necessary to form the remaining semi-circular section associated with the formed oval connector 98′ illustrated in FIG. 8. This method of fabrication eliminates the need for using the cut outs 106 in association with the strip of stock material 98 illustrated in FIG. 9. In this case, a strip of stock material having a substantially uniformly thick flanged portion such as the flanged portion 102 illustrated in FIG. 12 can be utilized to form the oval flanged connector or other oval member. In this case, no cut out portions 106 will result in the end product. It is also recognized and anticipated that other methods for forming the oval flanged connector 98′ may likewise be achieved through the use of the present curling device 10 as will be hereinafter further explained with respect to FIGS. 14-17.

The present curling device 10 can likewise be utilized to form other irregularly shaped flanged connectors for joining together correspondingly shaped HVAC duct work as well as other irregularly shaped members for use in a multitude of different industrial applications such as the triangular, octagonal and L-shaped members illustrated in FIGS. 18-20 as will likewise be hereinafter further explained. The present device improves the overall fabricating process for forming circular, oval and other irregularly shaped members for use in a wide variety of different industrial applications including joining together correspondingly shaped HVAC duct work; it substantially reduces the number of manual operations previously performed in order to form such members; it enables such flanged connectors and other members to be formed from a single piece of stock material; and the gap or space 44 between the pinch rollers 12 and 14 can be adjusted based upon the thickness of the stock material passing therebetween to produce any radius of curvature or diameter desired.

The disclosed embodiments have particular utility in all industrial applications where circular, oval or other irregularly shaped members are needed for holding, connecting, joining or otherwise mating together correspondingly shaped piping, housings, cabinets, duct sections and other applications. In this regard, although the present device 10 is illustrated in FIGS. 1 and 2 as a stand alone unit, it is recognized and anticipated that the present apparatus 10 can be integrated into an assembly process wherein appropriately shaped strips of flange material such as the material strips illustrated in FIGS. 6 and 9 can be formed and directly fed into the present apparatus. For example, one such assembly process is illustrated in FIGS. 14-17 wherein a roll former machine 110 is positioned adjacent the present device 10 so as to automatically feed strips of flanged shaped stock material from the roll former 110, through a cutter device 112, directly into the curling device 10 such as by aligning and feeding the stock material adjacent the infeed guide member 92 (FIG. 2) for passage through and between the pinch rollers 12 and 14 and the containment roller 16. In the particular arrangement illustrated in FIGS. 14-17, the roll former 110 receives a blank sheet or strip of sheet metal material and thereafter roll forms such material into an appropriately shaped strip of stock material such as the strip material 86 (FIG. 6) or 98 (FIG. 9) depending upon the particular shape of the desired flanged connector or other irregularly shaped member to be fabricated. As illustrated in FIG. 14, this particularly shaped strip of stock material 114 may be passed through an appropriate cutting device 112 and thereafter fed directly into the present apparatus 10 for forming the particularly shaped member.

In the particular process illustrated in FIGS. 14-17, another method for fabricating an oval shaped connector or other member similar to the connector 98′ illustrated in FIG. 8 is illustrated. This fabrication method differs from the method described with reference to FIGS. 8-12 in that the strip of stock flanged material 114 does not include the cut out portions 106 or the hem portion 104, but instead, represents an L-shaped strip of material having a cross-sectional shape similar to that disclosed in FIG. 7. As illustrated in FIG. 14, a continuous strip of stock material 114 is fed through the curling device 10 such that a substantially straight linear length A is allowed to pass therethrough. This is accomplished by appropriately adjusting the space or gap 44 between the pinch rollers 12 and 14 such that no compression forces are exerted against the stock material 114 as it passes between rollers 12 and 14. The advancement of the stock material 114 is then stopped as illustrated in FIG. 14 and the space or gap 44 is then appropriately adjusted so as to exert the necessary compression forces on the stock material 114 so as to form the first semi-circular section B of a particular oval connector or other member when the stock material 114 is again advanced through the curling device 10 as illustrated in FIG. 15. Once the first semi-circular section B is formed as illustrated in FIG. 15, the advancement of the stock material 114 is again stopped and the gap 44 is again adjusted so as to exert no compressive forces on the stock material 114 when advancement is continued.

Referring now to FIG. 16, stock material 114 is now further advanced through the curling machine 10 such that two linear sections A and one linear section B pass therethrough as illustrated. At this point, the advancement of stock material 114 is again stopped and an additional linear length A of strip material 114 is positioned for entry into the curling device 10 as illustrated in FIG. 16. Once this arrangement is achieved, the continuous strip of material 114 is severed as again illustrated in FIG. 16. The severing of the strip material 114 at the appropriate location is accomplished by cutter device 112 as the stock material is being fed therethrough. This severing may be accomplished by the operator moving the strip material 114 back and forth through the curling device 10 with no compressive forces being applied thereto in order to measure and sever the strip material 114 at the appropriate length. Once severing takes place, the strip material 114 is positioned and oriented as illustrated in FIG. 16.

FIG. 17 illustrates the final formation of an oval flanged connector or other oval member 115. This final fabrication is accomplished by positioning the stock material 114 as illustrated in FIG. 16 and thereafter again adjusting the gap 44 between pinch rollers 12 and 14 so as to exert the necessary compression forces to again generate the curling action and form the second semi-circular section of the oval connector. Once the gap 44 is properly adjusted, the curling device 10 is operated in a reverse direction such that the substantially straight linear section B illustrated in FIG. 16 is passed between the rollers 12 and 14 so as to form the second semi-circular section B of the finished oval connector 115 illustrated in FIG. 17. Advancing the stock material 114 in a reverse direction through curling device 10 will position the substantially straight linear portion A located between the cutter device 112 and the curling device 10 illustrated in FIG. 16 adjacent the substantially straight linear portion A illustrated in the lower portion of FIG. 16. Once the process illustrated in FIGS. 14-17 is completed, the finished oval connector 115 as illustrated in FIG. 17 can be removed from the curling device 10 by again adjusting the gap 44 so as to remove the connector from between the rollers 12,14 and 16. Once removed, the opposed end portions of the finished oval connector 115 can be welded or otherwise joined as previously discussed with respect to FIG. 8. It is recognized and anticipated that still other methods of operation of the present curling device 10 can be utilized to achieve differently shaped flanged and non-flanged members. In addition, as will be hereinafter explained, if electrical control means such as servo motor 54 are used to control the size of gap 44, or if the device 10 is computer controlled, the size of the gap 44 can be changed and adjusted on the fly and the device 10 will not have to be stopped in order to accomplish each such adjustment.

The inlet axis I and the outlet axis O are illustrated in FIG. 15. When the curling device 10 compresses the stock material 114, such compression force causes the stock material 114 to bend or curve away from the outlet axis O as illustrated. This bending or curving production technique is unique to cold forming machines. A typical cold forming machine will produce an elongated structural member such as C-shaped beams or Z-shaped beams that are produced as straight as possible along the outlet axis O. The purpose of the present device 10 is directly opposite to the prior art because the device 10 produces curved or arcuate connectors and other members that may be circular such as the member 86′ (FIG. 5), oval such as the members 98′ (FIG. 8) and 115 (FIG. 17), or irregularly shaped such as the members illustrated in FIGS. 18-21. When the pinch rollers 12 and 14 compress the stock material 114, the curved connectors or other arcuate members bend away from the outlet axis O during production as best illustrated in FIG. 15.

It is also recognized and anticipated that a conventional feed mechanism can likewise be utilized in association with the present curling device 10. For example, as illustrated in FIG. 3, an optional feed mechanism 116 can be appropriately positioned adjacent entry to the device 10 for assisting the feeding of strip material between the rollers 12, 14 and 16. As illustrated in FIG. 3, a typical feed mechanism 116 would include a pair of entry feed rollers 118 and 120 for properly aligning and feeding the stock flanged material between the rollers 12,14 and 16 of the present device 10. In order to accommodate different thicknesses of the stock flanged material being fed through the feed mechanism 116, it is recognized that the upper and/or lower feed rollers 118 and 120 may likewise be adjustably movable relative to each other in order to adjust and control the space therebetween. The upper entry feed roller 118 may likewise be appropriately biased towards the lower entry feed roller 120 so as to ensure that appropriate tension is applied to the stock material as it is being fed through the feed mechanism 116. This will also ensure proper feeding of such stock material into the pinch rollers 12 and 14. As shown in FIG. 3, the upper entry feed roller 118 is driven via conventional means such as by a chain or belt mechanism 122 which would be coupled to the upper spindle assembly 36 for rotation therewith in a conventional manner. In similar fashion, the upper entry feed roller 118 would be coupled to the lower entry feed roller 120 in a conventional manner for rotation therewith such as through a gearing arrangement similar to the arrangement of gear members 40 and 42 illustrated in FIG. 1. Use of the feed entry mechanism 116 would facilitate either hand feeding the stock flanged material into the present device 10, or such feed mechanism could likewise be utilized in any assembly line process such as the assembly configuration illustrated in FIGS. 14-17. Still further, it is recognized and anticipated that other feed mechanisms and other means for powering the same can likewise be utilized without departing from the spirit and scope of the present invention.

Although use and operation of the present curling device 10 has been illustrated with respect to the formation of circular and oval shaped flanged connectors, it is recognized and anticipated that other irregularly shaped connectors and other members such as the triangularly shaped member 124 illustrated in FIG. 18, the octagonally shaped member 126 illustrated in FIG. 19, and the L-shaped member 128 illustrated in FIG. 20 can likewise be easily fabricated from a strip of stock material in accordance with the teachings of the present invention. As previously explained with respect to the formation of the oval members illustrated in FIGS. 8 and 17, the various radii of curvature such as the radii 130,132,134 and 136 can be achieved by appropriately spacing the gap 44 between pinch rollers 12 and 14 so as to exert the necessary compression force against the stock material being fed therethrough to achieve the desired radius of curvature. In addition, the substantially straight linear sections of the respective members 124,126 and 128 such as the linear sections 138, 140,142, and 144 can likewise be formed by adjusting the space or gap 44 so as to exert no compressive force along the length of the stock material corresponding to such substantially straight linear wall sections when such sections pass between pinch rollers 12 and 14. Still further, it is also recognized and anticipated that conventional square or rectangular connectors, flanges brackets, stiffeners and/or coupling devices such as the member 146 illustrated in FIG. 21 can likewise be formed in a similar fashion utilizing the present curling machine 10.

Since it may necessary to adjust the space or gap 44 between pinch rollers 12 and 14 several times during a particular forming operation depending upon the particular shape of the desired end product, it is also recognized and anticipated that the adjustment mechanisms for adjusting the size of the gap 44, the position of the truing roller 70, and the positioning of the containment roller 16 can be electronically controlled via appropriate means so as to automatically control the forming process from start to finish. Electronic control of the present curling device 10 can be accomplished in a wide variety of different ways. For example, FIG. 22 is an exemplary schematic illustration of one embodiment of a control system 148 for adjusting the various parameters associated with the present device 10 based upon the desired shape of the connector or other member to be produced thereby. Control system 148 includes electronic control means in the form of an electronic controller or other processing means 150 which is capable of controlling various servo motors, actuators, and other control mechanisms for adjusting the various parameters associated with the device 10 such as controlling the size of the gap 44, the position of the truing roller 70, the position of the containment roller 16 if such roller is made adjustable, and other parameters. Electronic controllers such as the controller 150 are commonly used in association with work machines for accomplishing various tasks. In this regard, controller 150 would typically include processing means such as a microcontroller or microprocessor, associated electronic circuitry such as input/output circuitry, analog circuits and/or programmed logic arrays, as well as associated memory. Controller 150 can therefore be programmed to sense and recognize the appropriate signals indicative of the various conditions, states or actuations of various mechanisms associated with device 10 such as signals indicative of the size of the space or gap 44, the force or pressure exerted on the strip of stock material passing between pinch rollers 12 and 14, or signals indicative of the desired thickness of the flanged portions 90 and 102, the desired radius of curvature between connector sections, and the desired length of each connector section.

In this regard, an input device 152 is operatively connected via conductive path 154 to controller 150 for inputting various parameters relating to the formation of the desired end product such as the thickness of the flanged portion of the stock material (156), the desired overall length or circumference of the finished connector or other member (158), the total number of different connector or member sections (160), the desired length or circumference of each connector or member section (162), and the desired radius of curvature between each connector or member section (164). Input signals 156-164 could be inputted to controller 150 via input device 152 or, for example, in the case of inputting the thickness of the flanged portion passing through pinch rollers 12 and 14, appropriate sensors could be positioned prior to the stock material entering the rollers 12 and 14, such sensors being operable to determine such thickness and to output a signal representative of such thickness to controller 150. Input device 152 could take the form of a computer keyboard, a computer screen menu coupled with a keyboard for operatively selecting or inputting the desired parameters, or a computer touch screen menu where appropriate parameters can be inputted. Other operator selectable commands for selecting the desired parameters for input to controller 150 are likewise recognized and anticipated.

Based upon input signals 154, 156, 158, 160, 162 and 164, controller 150 will output appropriate signals to the appropriate control mechanisms such as the servo motor 54 to adjust the space or gap 44, to adjust the position of the truing roller 70, to adjust the position of the containment roller 16, and/or to start/stop operation of the device 10. In this regard, controller 150 will output a signal 166 to the appropriate control mechanism to adjust gap 44, a signal 168 to adjust the position of the truing roller 70, a signal 170 to adjust the position of the containment roller 16, and a signal 172 to either start or stop the operation of the device 10. Based upon the parameters inputted to controller 150, appropriate calibration tables, charts, maps and other data can be stored within the memory of controller 150 so as to determine the appropriate size and position of the gap 44 and rollers 16 and 70 so as to achieve the inputted radius of curvature and desired member shape. In this regard, controller 150 can be programmed to automatically perform the forming process illustrated in FIGS. 14-17 wherein advancement of the stock material 114 in either the forward or reverse direction through the curling device 10, the adjustment of the space or gap 44 at various times along the length of the stock material 114 to achieve both the substantially straight linear sections A as well as the semi-circular sections B, the adjustment of the position of the containment roller 16 and the position of the truing roller 70, and the starting and stopping of the pinch rollers 12 and 14 to achieve the formation of the various connector sections A and B are automatically controlled from start to finish once the input parameters are received by controller 150. The length of each connector section as well as the radius of curvature between adjacent sections can be easily programmed into controller 150 and the fabrication process can be substantially automated including outputting a signal to cutter 112 to cut the strip of stock material 114 at the appropriate length as illustrated in FIG. 16. It is recognized and anticipated that controller 150 could likewise be programmed to make all of the appropriate adjustments to gap 44, truing roller 70 and containment roller 16 on the fly without having to start and stop the operation of device 10. Still other control systems for accomplishing the forming of circular, oval and other irregularly shaped members can be utilized without departing from the spirit and scope of the present invention.

It is also recognized that the curling device 10 can likewise be utilized for making curved, oval and other irregularly shaped substantially flat, non-flanged members for use in a variety of different industrial applications. In this regard, the phrases “stock flanged material” and “stock material” as used herein are also intended to include substantially flat, non-flanged sheets or strips of material when circular, oval and other irregularly shaped substantially flat members are being formed. In this situation, a substantially flat non-flanged piece of stock material may be fed between pinch rollers 12 and 14 and adjacent to containment roller 16 in order to produce a curved, oval, arcuate or other irregularly shaped substantially flat, non-flanged member. Use of the present curling device 10 therefore affords a user or operator distinct advantages over the known prior art devices and methods for forming circular, oval and other irregularly shaped members.

Flange assemblies embodying the invention in general are an alternative to the second known technique briefly summarized above with reference to FIG. 25.

Referring to FIG. 26, schematically depicted is a machine 270 embodying the invention which makes generally L-shaped angled flanges for joining sections of round or flat oval ductwork from a single length of coiled steel stock. Each flange requires only a single joint 272 (FIG. 32) or 274 (FIG. 33).

As depicted in FIGS. 27 and 28, generally L-shaped flanges 276 and 278 are used to connect two sections 280 and 282 of flat oval or spiral ductwork, and/or fittings together. The flanges 276 and 278 have L-shaped profiles defined by respective duct-attachment legs 284 and 286 extending generally parallel to the longitudinal axis of the ductwork sections 280 and 282 being joined, and by respective flange-attachment legs 288 and 290 extending radially outwardly generally perpendicularly to the longitudinal axis of the ductwork sections 280 and 282 being joined. The duct-attachment legs 284 and 286 of the flanges 276 and 278 are secured to the two ductwork sections 280 and 282 with screws 292 and 294. Sealing is aided by beads of sealant 296 and 298. The flange-attachment legs 288 and 290 of the flanges 276 and 278 are secured to each other by clips 300. Mastic 302 is used between facing surfaces of the flanges 276 and 278.

In FIG. 26, a reel 310 supplies coiled steel stock 312 detailed in FIG. 29. An exemplary thickness is 0.0747 inch. The machine 270 has an input section 314 which receives the stock material. In particular, pinch rolls 316 grip the steel 312 as it is unwound from the reel 310.

The steel 312 is fed to cutter 318 such as a shear 318, which accurately cuts pieces of steel stock lengths 320 corresponding to the individual flanges being made. Thus, the lengths are determined by the desired final flange 276, 278 dimensions.

Next, a set 322 of angle-forming rolls forms each length 320 of sheet metal stock material into an angled length 324 of material having a generally L-shaped profile. A cross-sectional representation of each angled length 324 as it emerges from the angle-forming rolls 322 is depicted in FIG. 30, corresponding to the cross-sectional profile of the flanges 276 and 278. A duct-attachment leg 326 and a flange-attachment leg 328 are each approximately one inch long, and an edge roll 330 on the flange-attachment leg 325 is ⅜ inch long.

As a matter of convenience additional forming rolls (not shown) may be included with the angle-forming rolls 322, mounted opposite the angle-forming rolls 322, to manufacture clips 300 (FIGS. 27 and 28).

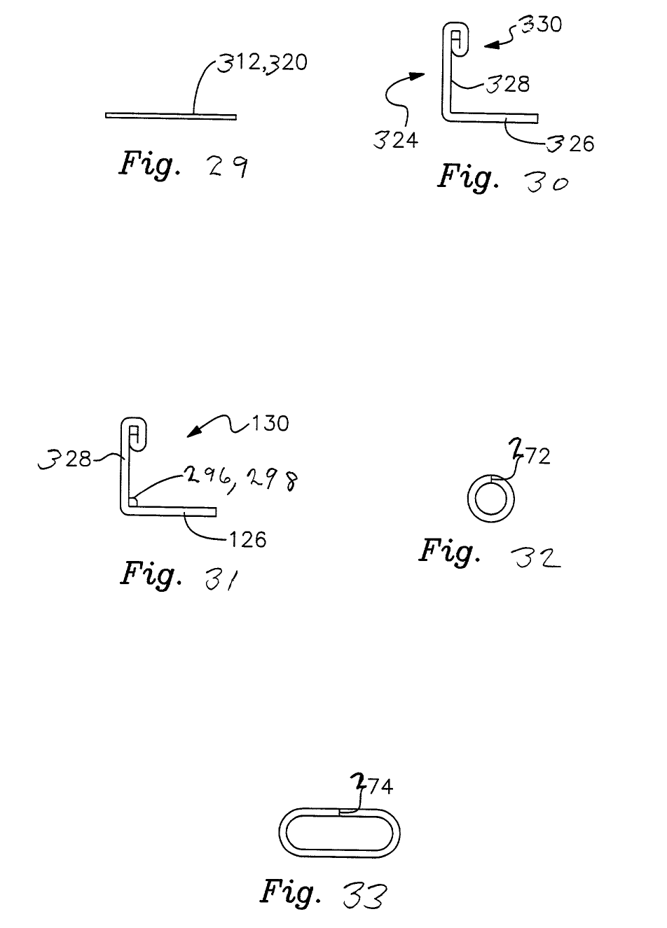

A sealant applicator 332 injects the sealant 96, 98 into the corner of the angled lengths 324, the result of which is depicted in FIG. 31.

Next, a set 340 of shaping rolls forms the angled lengths 324 of material into either flat oval or round flanges generally L-shaped in profile and requiring only a single joint. Thus, the shaping rolls 340 determine the final overall shape of the flange assembly 276, 278, such as round (FIG. 32) or flat oval (FIG. 33). Preferably the shaping rolls 340 are adjustable on the fly. In the case of a flange for round ductwork sections (FIG. 32), the diameter is determined in conjunction with the length determined by the shear 318. In the case of flat-oval (FIG. 33) the minor and major axis are determined in conjunction with the length as determined by the shear 318.

Overall operation of the machine 270 is directed by a controller 342, which calculates the necessary length of the flange 276, 278 assembly, the required positioning of the adjustable shaping rolls 340, and the quantity of components required.

Although the length 320 of steel stock and the angled length 324 are shown in isolation on either side of the angle forming rolls 322, this depiction is for clarity of illustration. In a practical machine 270, one stage can merge directly into a subsequent stage.

After a flange is formed, its two ends can be joined together in a variety of ways, either before or after insertion into a ductwork section. The two ends can be welded to each other. They can be riveted or otherwise fastened to each other (if overlapped) or to the ductwork and a reinforcement scab if not overlapped. In general, the round or flat oval flanges are inserted into the respective ends of ductwork sections to be joined, and the duct-attachment legs are attached to the respective ductwork sections. The flange-attachment legs are butted against each other, typically with an intermediate seal, and then fastened to each other.

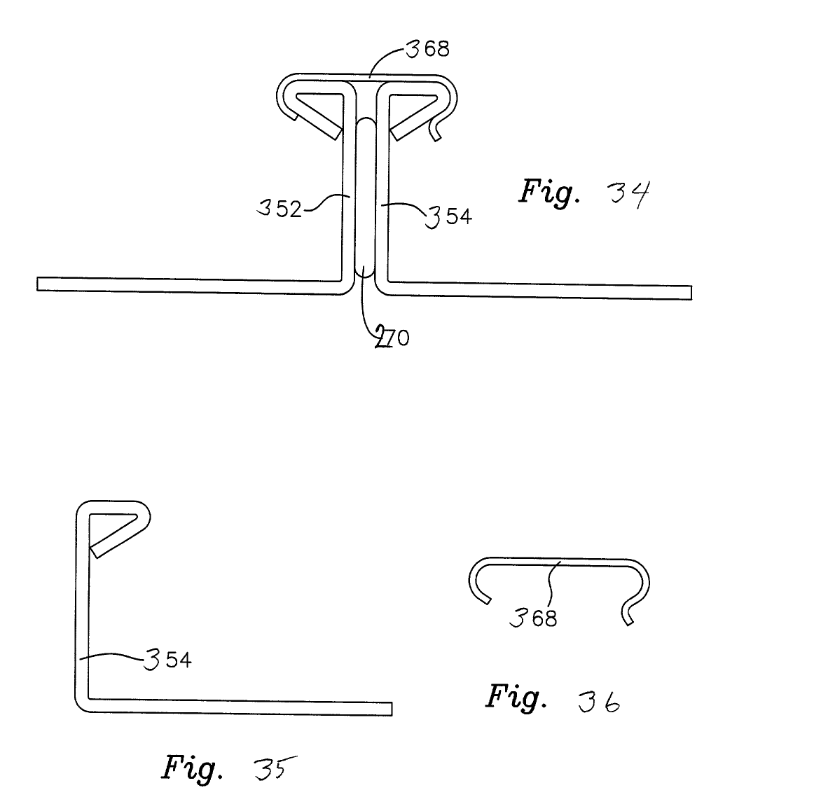

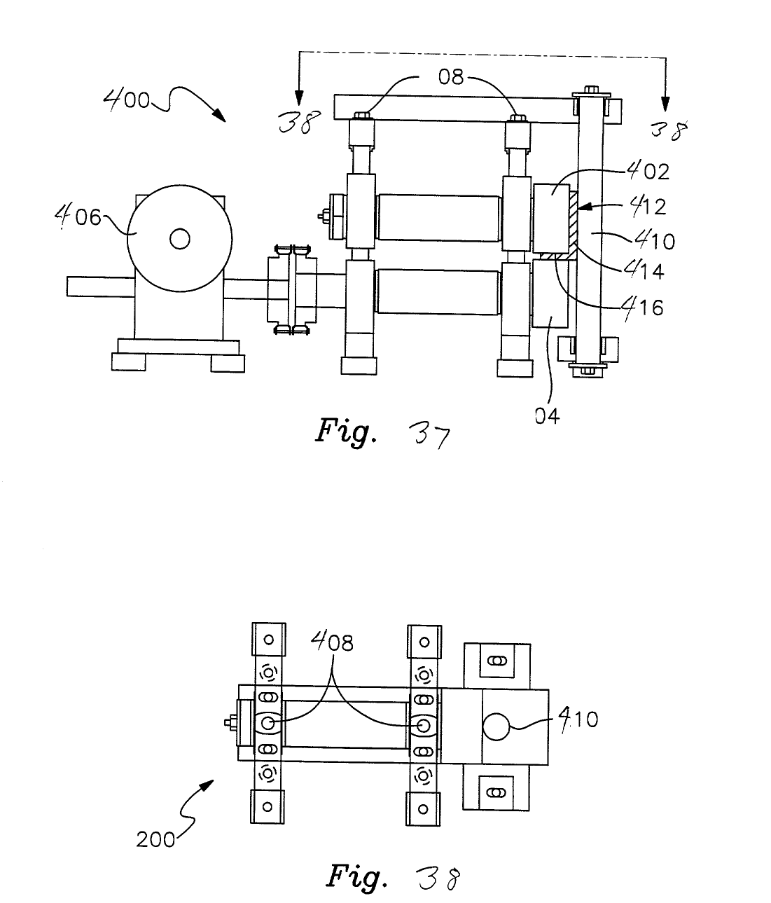

FIGS. 34, 35 and 36 depict alternative configurations to the clip and angle of FIGS. 27 and 30. In FIGS. 34 and 35, flanges 352 and 354 have a modified profile compared to the flanges 276 and 278 of FIG. 27, and in FIGS. 34 and 36 clip 368 has a modified profile compared to the clip 300 of FIG. 27.

Referring next to FIGS. 37 and 38, illustrated is a particular embodiment of a set of shaping rolls for forming the angled lengths of material into flat oval flanges generally L-shaped in profile and requiring a single joint. In particular, FIGS. 37 and 38 are simplified views of the curling device 10 as shown in FIGS. 1 and 2, described in detail hereinabove. For purposes of the summary description hereinbelow, the curling device 10 is referred to as curling machine 400.

The curling machine 400 includes upper and lower rolls 402 and 404, and the lower roll 404 is driven through suitable gearing by a motor 406. The spacing between the rolls 402 and 404 is adjustable, by means of an adjustment 408. The rolls 402 and 404 can rapidly be adjusted in spacing, automatically by the controller 342. In addition, there is a freely-turning vertical guide roller 410.

As shown in the side elevational view of FIG. 37 an angled length of material 412 (shown in cross section) having a duct-attachment leg 414 and a flange-attachment leg 416 passes between the rollers 402 and 404 such that the flange-attachment leg 416 is deformed by rolling to a reduced thickness along selected portions of the length where curvature or curling is required.

Thus, with reference to FIG. 39, the length 412 of angled material is fed between the rollers 402 and 404 with the spacing between the rollers 402 and 404 set such that deforming of the flange-attachment leg 416 does not occur, initially producing a straight section.

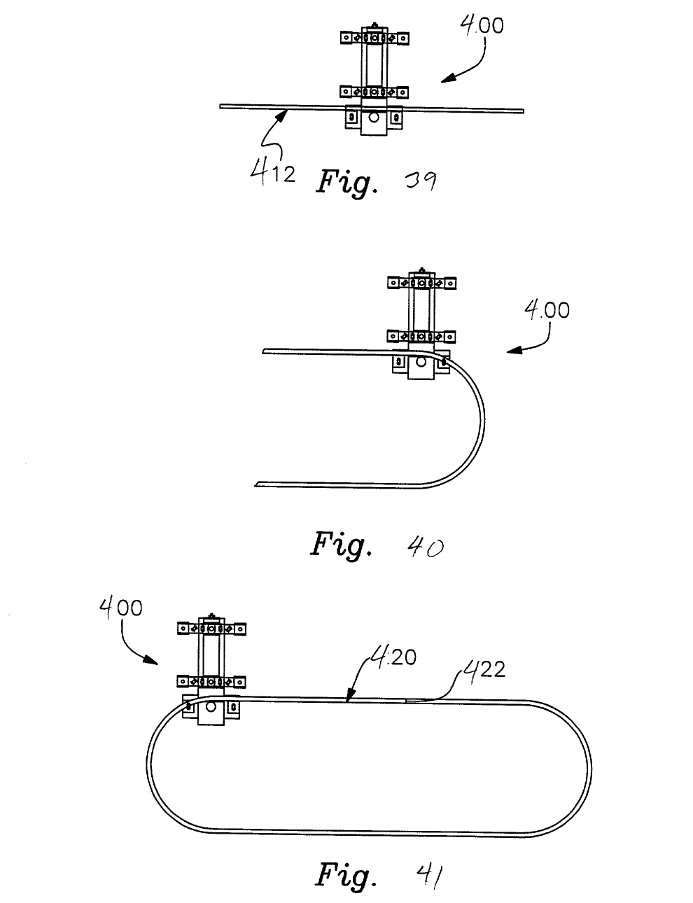

Next, as depicted in FIG. 40, under control of the controller 342, the rolls 402 and 404 are brought closer together, thereby rolling the flange-attachment leg 416 to a reduced thickness, to effect the desired degree of curling or curvature.

For a subsequent straight section, the spacing between the rollers 402 and 404 is again relaxed.

For the next curved section, the rollers 402 and 404 are again brought closer together, forming the final curved end section, resulting in a flat oval flange 420 requiring only a single joint 422, as shown in FIG. 41.

The subject invention accordingly provides a number of advantages.

Rather than conventional angle iron stock which typically is available in twenty foot lengths, low cost coiled steel is used. Scrap is essentially eliminated.

Sealant 494, 496 is pre-applied to the flanges 476, 478. This allows the joint to be assembled without having to manually apply duct-to-flange sealant.

With flat oval flanges, only one seam is required. In contrast, the second known technique described above (FIG. 25), requires four seams to join the four pieces of flange for a flat-oval flange.

The clips 300 allow the flanges 276, 278 to be attached to each other without having to line up bolt holes and without having to use cumbersome wrenches and pliers to fastened ductwork sections together.

The lighter weight material makes the flange 276, 278 easier to handle, and less costly as less steel is used. At the same time, the triple thickness of the material (324, FIG. 30) after the angle-forming rollers 322 provides added strength and stiffness.

The flanges 276, 278 fasten directly to the sheet metal ductwork sections 280 and 282 (or fittings), without the need for predrilled holes or welding the flange to the ductwork.

Similarly, with the clip assembly 300, the flanges 276, 278 do not have to have bolt holes line up perfectly as is required in the conventional flange of FIG. 25.

The machine thus forms flat coiled steel into an angle profile that is used to join round and flat oval ductwork and fittings. The inner radius of the angle has a sealant applied to it that serves as a gasket for the sealing of the ductwork to the flange. The formed angle flange slips into the ductwork/fitting and seals against the sealant. After the flange is secured by screwing it to the ductwork, a gasket is applied to the flat edge of the flange, the flanges are butted together and a connector clip is installed.

The machine is computer controlled and can be programmed to operate and produce any diameter of round and flat oval shapes.

Previously, the connector methods have been to use either a slip coupling or handmade flange assembly. The slip connector only works for small to medium size ductwork that is carrying low pressure. The flange method is timely to produce and requires extensive sealing after the joint is made.

The subject invention utilizes simple gasketing material to avoid the labor intensive process of duct sealing.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly attended that the claims set forth below shall cover all such changes, modifications, variations and other uses and applications that do not depart from the spirit and scope of the present invention as described herein.

Other aspects, objects and advantages of the present invention can be obtained from a study of the drawings, the disclosure and the appended claims.

What is claimed is:

1. An apparatus for forming a curved connector and other arcuate members from stock material comprising:
a pair of pinch rollers mounted on a support structure, said pinch rollers defining a gap therebetween having an inlet axis and an outlet axis, both the inlet axis and the outlet axis being in alignment with each other, at least a portion of the stock material being fed into the gap between the pinch rollers along the inlet axis;
power means operatively connected to at least one pinch roller for rotating said pair of pinch rollers;
an adjustment apparatus to selectively vary the gap between said pinch rollers so as to vary the amount of compression force being exerted on at least a portion of the stock material as at least a portion of the stock material passes therethrough; and
a containment roller positioned proximate the gap between the said pinch rollers, the compression force exerted on at least a portion of the stock material causing the stock material to curve away from the outlet axis as the stock material exits said pinch rollers.

2. The apparatus of claim 1 further including a work platform surrounding a portion of the gap between the pinch rollers, the work platform being aligned along the inlet and the outlet axis to support the stock material while being fed into the gap and to support the curved connector and other arcuate members after being formed by the pinch rollers.

3. The apparatus of claim 1 wherein said power means includes a motor operatively connected to at least one pinch roller.

4. The apparatus of claim 1 wherein said power means includes a drive assembly operatively connected to at least one pinch roller.

5. The apparatus of claim 1 wherein said containment roller is selectively adjustable relative to said pinch rollers so as to define a space therebetween.

6. The apparatus of claim 1 wherein said containment roller functions as a guide member for guiding at least a portion of the stock material between said pinch rollers.

7. The apparatus of claim 1 wherein said containment roller receives at least a portion of the transverse component of the compression force being exerted on at least a portion of the stock material as at least a portion of the stock material passes between said pinch rollers.

8. The apparatus of claim 1 including a truing roller positioned downstream from said containment roller, the truing roller engaging at least a portion of the stock material after it passes through said pinch rollers to maintain consistency of curvature in the curved portion of the stock material.

9. The apparatus of claim 8 wherein said truing roller is selectively adjustable relative to said containment roller.

10. An apparatus for forming a curved connector and other arcuate members from L-shaped stock material having a flange portion and a wall portion, the apparatus comprising:
a pair of pinch rollers mounted for rotation on a support structure, the pinch rollers defining a gap to receive the flange portion of the L-shaped stock material;
a motor operatively connected to at least one of said pinch rollers for rotating said pinch rollers;
an adjustment apparatus to selectively vary the gap between said pinch rollers so as to vary the amount of compression force being exerted on the flange portion of the L-shaped stock material as the flange portion passes therethrough, the compression force causing at least a portion of the L-shaped stock material to bend so as to form a curved section in the L-shaped stock material; and
a containment roller positioned adjacent the gap between the pinch rollers, said containment roller being in contact with the wall portion of the L-shaped stock material as the stock material passes through said pinch rollers.

11. The apparatus of claim 10 wherein said pinch rollers are mounted on upper and lower shafts positioned respectively in upper and lower frames, and wherein said adjustment apparatus further includes a manual adjustment mechanism having elongate support posts extending through at least one upper frame, the support posts being secured on one end to a stationary member and on the other end to a support member, the support posts functioning as a guide to allow the at least one upper frame to travel along the support posts, an elongate threaded member extending through the support member and being secured at one end to the at least one upper frame and at the other end to a fastening member such that rotation of the fastening member will correspondingly move the at least one upper frame to vary the gap between said pinch rollers.

12. The apparatus of claim 10 wherein said pinch rollers are mounted on upper and lower shafts positioned respectively in upper and lower frames, and wherein said adjustment apparatus further includes elongate support posts which extend through at least one upper frame, the support posts being secured on one end to a stationary member and on the other end to a support member, the support posts functioning as a guide to allow the at least one upper frame to travel along the support posts, an actuator mounted on the support member and a rod extending from the actuator through the support member and operatively connected to the at least one upper frame such that operation of the actuator moves the rod and will correspondingly move the at least one upper frame to vary the gap between said pinch rollers.

13. The apparatus of claim 10 wherein said containment roller is selectively adjustable relative to said pinch rollers so as to define a space therebetween, the wall portion of the L-shaped stock material passing through said space.

14. The apparatus of claim 10 further including a truing roller positioned downstream from said containment roller, said truing rolling engaging the stock material after it passes through said pinch rollers to maintain consistency of curvature in the curved section of the L-shaped stock material.

15. A method for forming a curved connector and other arcuate members from stock material comprising the following steps:
providing a pair of pinch rollers mounted on a support structure, said pinch rollers defining a gap therebetween having an inlet axis and an outlet axis in alignment with each other;
rotating said pinch rollers;
adjusting the gap between the pinch rollers to control the amount of compression force being exerted on at least a portion of the stock material as at least a portion of the stock material passes therethrough, the compression force exerted on at least a portion of the stock material causing the stock material to curve away from the outlet axis as the stock material exits the pinch rollers; and
feeding at least a portion of the stock material in between said pair of pinch rollers along the inlet axis.

16. The method of claim 15 including the step of providing a containment roller positioned adjacent the gap between said pinch rollers.

17. The method of claim 16 including the step of providing a truing roller positioned downstream from said containment roller, said truing roller engaging the stock material after it passes through said pinch rollers to help true up the curved portion of the stock material.

18. The method of claim 17 wherein said truing roller is selectively adjustable relative to said containment roller.

19. A method for forming a curved connector and other arcuate members from L-shaped stock material having a flange portion and a wall portion, the method comprising the steps of:
providing a pair of pinch rollers mounted for rotation on a support structure, said pinch rollers defining a gap to receive the flange portion of the L-shaped stock material;
rotating said pinch rollers to move the stock material through the gap in said pinch rollers;
adjusting the gap between said pinch rollers to control the amount of compression force being exerted on the flange portion of the L-shaped stock material as the flange portion passes therethrough, the compression force causing at least a portion of the L-shaped stock material to bend so as to form a curved portion in the L-shaped stock material; and
feeding the flanged portion of the L-shaped stock material in between said pair of pinch rollers.

20. The method of claim 19 including the step of providing a containment roller positioned adjacent the gap between said pinch rollers, said containment roller being in contact with the wall portion of the L-shaped stock material as the stock material passes through said pinch rollers.

21. The method of claim 20 including the step of providing a truing roller positioned downstream from said containment roller, said truing roller engaging the stock material after it passes through said pinch rollers to maintain the consistency of curvature in the curved portion of the L-shaped stock material.

22. An apparatus for spiral forming circular connectors from stock material comprising:
a pair of pinch rollers mounted on a support frame, said pinch rollers defining a gap therebetween to receive the stock material;
power means operatively connected to at least one pinch roller for rotating said pair of pinch rollers;
an adjustment apparatus to selectively vary the gap between said pinch rollers so as to vary the amount of compression force being exerted on at least a portion of the stock material as at least a portion of the stock material passes therethrough; and
a containment roller positioned proximate the gap between said pinch rollers, the compression force exerted on at least a portion of the stock material creating a continuous spiral in the stock material after passing through said pinch rollers.

23. The apparatus of claim 22 including a deflector to divert the continuous spiral of stock material away from said pinch rollers to prevent interference with the movement of the stock material through said pinch rollers.

24. A method for spiral forming circular connectors from stock material comprising the following steps:
providing a pair of pinch rollers mounted on a support structure, said pinch rollers defining a gap therebetween for receiving the stock material;
rotating said pinch rollers;
adjusting the gap between said pinch rollers to control the amount of compression force being exerted on at least a portion of the stock material;
providing a containment roller positioned proximate the gap between said pinch rollers;
feeding at least a portion of the stock material in between said pair of pinch rollers, the compression force exerted on at least a portion of the stock material causing a continuous spiral in the stock material after passing through said pinch roller; and
deflecting the continuous spiral of stock material away from said pinch rollers to prevent interference with the movement of the stock material therethrough.

25. The method of claim 24 including the step of cutting the continuous spiral of stock material into segments.

26. The method of claim 25 including the step of joining each segment of stock material, after cutting, to form a circular connector.

27. A system for forming a curved connector and other arcuate members from flat continuous stock material comprising:
a roll forming machine to cold form the flat continuous stock material into continuous L-shaped material having a flange portion and a wall portion;
an apparatus to cold form the L-shaped material into curved connectors and other arcuate members; and
a cutter positioned between the roll forming machine and the cold forming apparatus to cut the continuous L-shaped material into sections;
said cold forming apparatus including:
a pair of pinch rollers mounted on a support structure, said pinch rollers defining a gap therebetween having an inlet axis and an outlet axis, both the inlet axis and the outlet axis being in alignment with each other, at least a portion of the stock material being fed into the gap between the pinch rollers along the inlet axis;
power means operatively connected to at least one pinch roller for rotating said pair of pinch rollers;
an adjustment apparatus to selectively vary the gap between the said pinch rollers so as to vary the amount of compression force being exerted on at least a portion of the stock material as at least a portion of the stock material passes therethrough; and
a containment roller positioned proximate the gap between the said pinch rollers, the compression force exerted on at least a portion of the stock material causing the stock material to curve away from the outlet axis as the stock material exits said pinch rollers.

28. The system of claim 27 wherein said containment roller is in contact with the wall portion of the L-shaped stock material as the stock material passes through said pinch rollers.

29. The system of claim 27 wherein said containment roller is selectively adjustable relative to said pinch rollers.

30. The system of claim 27 including a truing roller positioned downstream from said containment roller, said truing roller engaging the stock material after it passes through said pinch rollers.

31. The system of claim 30 wherein said truing roller is selectively adjustable relative to said containment roller.

32. The system of claim 27 including a controller coupled to the system, said controller including an operator input device to enter operational parameters and being operable to control mechanisms to adjust the gap between said pinch rollers.

33. The system of claim 32 wherein said containment roller is selectively adjustable relative to said pinch roller, and wherein said controller is operable to adjust the position of said containment roller relative to said pinch rollers.

34. The system of claim 32 wherein said controller is operable to start and stop the cold forming apparatus.

35. A machine for making generally L-shaped flanges for joining sections of flat oval ductwork, said machine comprising:
an input section for receiving a strip of sheet metal stock material;
a cutter for cutting the sheet metal stock material into lengths corresponding to individual flanges being made;
a set of angle-forming rolls for forming each length of sheet metal stock material into an angled length of material having a generally L-shaped profile with a flange portion and a wall portion; and
a set of shaping rolls for forming the angled lengths of material into flat oval flanges generally L-shaped in profile and requiring only a single joint, said set of shaping rolls including
a pair of pinch rollers mounted for rotation on a support structure and through which the angled lengths of material are driven, the pinch rollers defining a gap to receive the flange portions of the angled lengths of material,
an adjustment apparatus to selectively vary the gap between said pinch rollers so as to vary the amount of compression force being exerted on the flange portion of the angled lengths of material as the flange portion passes therethrough, the compression force causing at least a portion of the angled lengths of material to bend so as to form a curved section in the angled lengths of material, and
a containment roller positioned adjacent the gap between the pinch rollers, said containment roller being in contact with the wall portion of the angled lengths of material as the angled lengths pass through said pinch rollers.

36. The machine of claim 35 wherein said pinch rollers are mounted on upper and lower shafts positioned respectively in upper and lower frames, and wherein said adjustment apparatus further includes a manual adjustment mechanism having elongate support posts extending through at least one upper frame, the support posts being secured on one end to a stationary member and on the other end to a support member, the support posts functioning as a guide to allow the at least one upper frame to travel along the support posts, an elongate threaded member extending through the support member and being secured at one end to the at least one upper frame and at the other end to a fastening member such that rotation of the fastening member will correspondingly move the at least one upper frame to vary the gap between said pinch rollers.

37. The machine of claim 35 wherein said pinch rollers are mounted on upper and lower shafts positioned respectively in upper and lower frames, and wherein the adjustment apparatus further includes elongate support posts which extend through at least one upper frame, the support posts being secured on one end to a stationary member and on the other end to a support member, the support posts functioning as a guide to allow the at least one upper frame to travel along the support posts, an actuator mounted on the support member and a rod extending from the actuator through the support member and operatively connected to the at least one upper frame such that operation of the actuator moves the rod and will correspondingly move the at least one upper frame to vary the gap between said pinch rollers.

38. The machine of claim 35 wherein said containment roller is selectively adjustable relative to said pinch rollers so as to define a space therebetween, the wall portion of the angled lengths of stock material passing through said space.

39. The machine of claim 35 further including a truing roller positioned downstream from said containment roller, said truing rolling engaging the stock material after it passes through said pinch rollers to maintain consistency of curvature in the curved section of the angled lengths of material.

40. A machine for making generally L-shaped flanges for joining sections of flat oval ductwork, said machine comprising:
an input section for receiving a strip of sheet metal stock material;
a cutter and a set of angle-forming rolls for making out of the strip of sheet metal angled lengths of material having a generally L-shaped profile with a flange portion and a wall portion, the angled lengths of material having lengths corresponding to individual flanges being made; and
a set of shaping rolls for forming the angled lengths of material into flat oval flanges generally L-shaped in profile and requiring only a single joint, said set of shaping rolls including
a pair of pinch rollers mounted for rotation on a support structure and through which the angled lengths of material are driven, the pinch rollers defining a gap to receive the flange portions of the angled lengths of material,
an adjustment apparatus to selectively vary the gap between said pinch rollers so as to vary the amount of compression force being exerted on the flange portion of the angled lengths of material as the flange portion passes therethrough, the compression force causing at least a portion of the angled lengths of material to bend so as to form a curved section in the angled lengths of material, and
a containment roller positioned adjacent the gap between the pinch rollers, said containment roller being in contact with the wall portion of the angled lengths of material as the angled lengths pass through said pinch rollers.

41. The machine of claim 40 wherein said pinch rollers are mounted on upper and lower shafts positioned respectively in upper and lower frames, and wherein said adjustment apparatus further includes a manual adjustment mechanism having elongate support posts extending through at least one upper frame, the support posts being secured on one end to a stationary member and on the other end to a support member, the support posts functioning as a guide to allow the at least one upper frame to travel along the support posts, an elongate threaded member extending through the support member and being secured at one end to the at least one upper frame and at the other end to a fastening member such that rotation of the fastening member will correspondingly move the at least one upper frame to vary the gap between said pinch rollers.

42. The machine of claim 40 wherein said pinch rollers are mounted on upper and lower shafts positioned respectively in upper and lower frames, and wherein the adjustment apparatus further includes elongate support posts which extend through at least one upper frame, the support posts being secured on one end to a stationary member and on the other end to a support member, the support posts functioning as a guide to allow the at least one upper frame to travel along the support posts, an actuator mounted on the support member and a rod extending from the actuator through the support member and operatively connected to the at least one upper frame such that operation of the actuator moves the rod and will correspondingly move the at least one upper frame to vary the gap between said pinch rollers.

43. The machine of claim 40 wherein said containment roller is selectively adjustable relative to said pinch rollers so as to define a space therebetween, the wall portion of the angled lengths of material passing through said space.

44. The machine of claim 40 further including a truing roller positioned downstream from said containment roller, said truing rolling engaging the angled lengths of material after passing through said pinch rollers to maintain consistency of curvature in the curved section of the angled lengths of material.

45. A machine for making generally L-shaped flanges for joining sections of round ductwork, said machine comprising:
an input section for receiving a strip of sheet metal stock material;
a cutter for cutting the sheet metal stock material into lengths corresponding to individual flanges being made;
a set of angle-forming rolls for forming each length of sheet metal stock material into an angled length of material having a generally L-shaped profile with a flange portion and a wall portion; and
a set of shaping rolls for forming the angled lengths of material into flat oval flanges generally L-shaped in profile and requiring only a single joint, said set of shaping rolls including
a pair of pinch rollers mounted for rotation on a support structure and through which the angled lengths of material are driven, the pinch rollers defining a gap to receive the flange portions of the angled lengths of material, the gap being such that compression force is exerted on the flange portion of the angled lengths of material as the flange portion passes therethrough, the compression force causing the angled lengths of material to bend so as to form a curve, and
a containment roller positioned adjacent the gap between the pinch rollers, said containment roller being in contact with the wall portion of the angled lengths of material as the angled lengths pass through said pinch rollers.

46. The machine of claim 45 wherein said containment roller is selectively adjustable relative to said pinch rollers so as to define a space therebetween, the wall portions of the angled lengths of material passing through said space.

47. The machine of claim 45 further including a truing roller positioned downstream from said containment roller, said truing rolling engaging the angled lengths of material after passing through said pinch rollers to maintain consistency of curvature.
